(19) United States
(12) Patent Application Publication
(10) Pub. No.: US 2019/0064364 A1
(43) Pub. Date: Feb. 28, 2019

(54) METHODS AND SYSTEMS FOR MOTION DETERMINATION OF SENSOR ELEMENTS IN SENSOR SYSTEMS USING MEMS IMUs

(71) Applicant: Motion Engine, Inc., Montreal (CA)

(72) Inventors: Robert Mark Boysel, Honeoye Falls, NY (US); Louis Ross, Montreal (CA)

(21) Appl. No.: 16/046,764

(22) Filed: Jul. 26, 2018

Related U.S. Application Data
(63) Continuation-in-part of application No. PCT/US2017/015393, filed on Jan. 27, 2017.
Application No. PCT/US2017/015393 is a continuation-in-part of application No. 15/206,935, filed on Jul. 11, 2016.
(60) Provisional application No. 62/288,878, filed on Jan. 29, 2016.

(51) Int. Cl. G01S 17/93; G01S 7/486; G05D 1/02

(52) U.S. Cl. CPC G01S 17/933; G01S 7/4863; G01S 17/936; B64C 2201/021; G05D 1/0231; G05D 1/027; G05D 1/0206; G05D 1/0202

(57) ABSTRACT

Systems and methods are provided for determining the position of sensor elements in a sensor system. The sensor system includes a plurality of sensor elements. The platform comprises a plurality of MEMS IMUs, each associated with one of the sensor elements, measuring the acceleration and angular rate of the sensor elements. A controller determines the position and attitude of the sensor elements, based on the acceleration and angular rate measured by each of the MEMS IMUs.

### RELATED APPLICATIONS

The present application is a continuation-in-part of International Application No. PCT/US2017/015393, filed on Jan. 27, 2017, which is a continuation-in-part of U.S. patent application Ser. No. 15/206,935, filed Jul. 11, 2016, and claims priority to U.S. Provisional Patent Application No. 62/288,878, filed Jan. 29, 2016, the contents of all of these applications being incorporated herein by reference in their entirety.

### TECHNICAL FIELD

The present invention relates to systems and methods used to determine and/or compensate for the motion of individual sensors in sensor arrays such as sonars and radars. More particularly, the present invention relates to the use of Micro Electro Mechanical System Inertial Measurement Units (MEMS IMUs) in sensor arrays.

### BACKGROUND

A sensor array is a collection of sensors, usually arranged in an ordered pattern, used for collecting and processing electromagnetic or acoustic signals. The sensors can be active (transmitter/receiver module arrays) or passive (receive only). For example, an array of radio antenna elements used for transmitting and receiving, either with or without beamforming can increase the gain in the direction of the signal while decreasing the gain in other directions by the use of shifting phase. An example of a passive application is the use of a sensor array to estimate the direction of arrival of electromagnetic waves. The sensor “array” can also be a synthetic or distributed antenna or virtual array consisting of as few as a single element moving in space with measurements made at multiple times, and hence, positions, up to hundreds, thousands, or more elements. These applications include synthetic aperture radar (SAR) and sonar and radio direction finding (RDF).

Sensor arrays are sensitive in one way or another to motion, including the overall motion of the system, and to internal distortions of the system. The accuracy of signal processing, particularly processing over time, is limited by platform and sensor motion detection and compensation methods. In fact, motion compensation techniques are one of the key limits to overall system performance. For sensor arrays such as phased array radars or sonars, the phase of each transducer in the array must be controlled, typically by time delays. Consequently, accurate timing is important. However, if the transducers are moving relative to each other, additional time delays must be added or subtracted to correct for errors in the relative phase delays. At some frequencies of interest, the wavelengths can be on the order of millimeters. At such frequencies, very small submillimeter vibrations can affect the signal resolution.

Synthetic aperture radars need to accurately track the position and velocity of the sensor array and the individual elements over time, so having accurate data about the position of the transducers as a function of time is important. Again, not only is the overall position of the array in time important, but also the position of the transducers relative to each other. This can be particularly important with towed sonar arrays which can be flexible and can move considerably perpendicular to the azimuthal, or travel, direction.

Referring to FIG. 1, most sensor arrays 100 have an Inertial Navigation System (INS) 101 that is located with or near the sensing platform 102. In the earliest days of development of arrayed radar systems, coarse motion detection was often performed by using information from aircraft Inertial Measurement Units (IMUs) because the cost, size/weight/power (SWAP) of the IMUs were so high that they were limited to one per aircraft. For underwater sonar applications, the new technology of Synthetic Aperture Sonar (SAS) uses high quality INS. Smaller SWAP ‘strapdown’ IMUs can now be integrated directly onto the radar antenna gimbal assembly, chassis, or optical sensor gimbal assembly. Strapdown IMUs greatly increased the accuracy of useful motion data, as the physically closely coupled IMUs can provide information directly from the sensor assembly while reducing extraneous motion information, such as platform motion, moment arms, platform vibration, distortion of the platform chassis or fuselage, etc. But even this class of IMU, used on state of the art tactical sensor arrays, typically uses Ring Laser Gyroscopes (RLGs) or Fiber Optic Gyroscopes (FOGs). The IMUs in this class are large, occupying about 170 cubic inches (2.8 liters), and is expensive, costing USD $20,000 to $100,000 each. These large, expensive IMUs must be carefully mounted and weight-compensated, as the state of the art is to dynamically balance the sensor gimbals to provide the most responsive movement possible.

Referring to FIG. 2A, a schematic representation of a sensor array is illustrated. In this example, the sensor array 200 includes a plurality of sensor elements 2101 that transmit signals, the phases of which are delayed one relative to the others in order to generate a wavefront pointing in a desired direction. Sensor arrays, such as phase arrays, transmit and/or detect by coherent combination of data from successive signals, either electromagnetic radar pulses or sonar acoustic pings. Motion detection for Synthetic Aperture Radars (SAR) and Synthetic Aperture Sonar (SAS) must be performed with accuracy better than a fraction of a wavelength along the synthetic aperture; and system accuracy requires precise knowledge of the positions of the sensor array elements. Motion compensation based on that motion detection is a key process that enables both SAS and SAR performance.

The gimbal-mounted strapdown IMU approach, in which the IMU is attached to an appropriate location on the gimbal assembly itself, cannot account for a wide range of motions that can occur between the location of the strapdown IMU and the actual sensor aperture (i.e., the radar face or FLIR optical window). These motions include various movement or aerodynamic induced torsional movements, heat driven distortions, vibrations, bearing rumble, drive motor and gear rumble, gear backlash, toothed drive belt stretch and contraction, or drive train jump. G forces and thermal loading can also distort the aperture itself, or its mounts. This movement and distortion is typically not uniform across the aperture, meaning that some portions of the aperture may move more and in a different manner than other portions of the aperture, thereby distorting the wavefronts as illustrated in FIG. 2B. Synthetic Aperture sensor array motion, whether airborne or seaborne, in along-track displacement (surge), cross-track displacement (sway) and cross-track rotation (yaw) induces errors that reduce accuracy and hence resolution. At certain frequencies, platform vibration or even deformation of the phased array can affect resolution. This is illustrated in FIGS. 3A to 3C. FIG. 3a shows two sensor elements unaffected by any torsion or vibration. The phase (I) is changed appropriately so as to generate a wavefront pointing in the desired direction, at an angle 0 from a normal vector. FIGS. 3B and 3C provide two examples of sensor elements 310i and 310ii in which relative position and/or orientation has changed compared to the “ideal” case shown in FIG. 3A. This undesired motion causes a shift in the phase (I), resulting in an undesired change of the pointing direction of the wavefront. Referring to FIG. 3B, vibration of the elements along the normal to the array can change their relative phase (shown as δϕ) and alter or broaden the beam pointing angle (δθ). However, as shown in FIG. 3C, twisting of the surface can cause a displacement of the elements which can also produce a phase shift and beam pointing error. These unmeasured and unaccounted for movements, while small, are significant at the frequencies of modern high frequency radars and sonars.

In light of the preceding, various challenges still exist for determining and/or compensating for the motion of the sensor elements, such as transmit and/or receive (T/R) modules of a radar or sonar.

### SUMMARY

In accordance with an aspect, a system and a method for determining the position of sensor elements in a sensor array are provided. The sensor array comprises a plurality of sensor elements, which are optionally arranged in an array. The system comprises a plurality of MEMS IMUs, each associated with one or more of the sensor elements of the sensor array. In some embodiments, a MEMS IMU comprises a MEMS inertial sensor mounted with an integrated circuit (IC) chip. Preferably, the MEMS sensor has six or more degrees of freedom (DOF), and is able to measure both acceleration and angular rate of movement. The system further comprises a controller for determining at least one of the attitude and the position of the sensor elements, based on the acceleration and angular rate measured by the MEMS IMUs. Preferably, the MEMS IMUs are mounted directly onto or in close proximity to the radio frequency (RF) or acoustic element transmit/receive apertures.

In some embodiments, the MEMS IMU includes a low-drift clock for accurate timing. The clock may be a MEMS clock integrated into the MEMS chip or a MEMS or quartz clock integrated in the IC. Check signals can also be provided by a clock mounted on a circuit board with the MEMS sensor, or from a system processor or from a remote networked clock.

In some embodiments, the system further comprises an inertial navigation unit (INU), and the controller also determines or estimates the attitude and position of the sensor elements based on measurement signals from the INU. The system can included programmed data that includes reference positions for the sensor elements. This position reference data can represent a static position of the sensor array elements, or position data using fixed coordinates or a computed position data such as an average over time. This can define the platform position from which adjusted position data are computed as described herein to alter a transmission or reception characteristic of one or more sensor elements at any point in time. The beamsteering and/or beamforming operation of the array can thereby be precisely controlled to improve array detection and imaging capabilities.

In some embodiments, the system calculates an average position and attitude of the sensor elements based on acceleration and angular rate measured by the MEMS IMUs, and based on the attitude or position estimated from the INU.

In some embodiments, the attitude and position measured by the MEMS IMU is used to determine a phase shift to apply to each sensor element to change the array beam pointing angle. The phase shifting can be applied using different types of circuits used to delay the transmission pulse at each transmission sensor element or channel and/or apply selected delays at each receive sensor element or channel. The beamsteering and beamforming circuits can comprise digital beamforming integrated circuits, or alternatively, can comprise charge coupled devices (CCDs) having a plurality of channels fabricated on one or more integrated circuits. The phase delay circuits are programmable and can be adjusted in response to the position and motion data generated by the inertial measurement array of sensors that is distributed across the sensor array. The system of controller or processor is programmable and includes one or more memories that store executable software modules including modules that control beam scanning parameters such as amplitude, phase, and frequency of transducers in a sensor array, for example.

In some embodiments, the controller includes a filter which filters out high frequency vibrational IMU data from low frequency navigational data. The attitude and/or position of each sensor element provided with a MEMS IMU is measured from the long term navigation data. The attitude and position of the platform can be determined by averaging the position data from each MEMS IMU. The position and/or attitude of each IMU relative to the platform can be determined, using local short term vibrational data. The desired phase of each sensor element is next determined based on a predetermined pointing angle. Optionally, the phase is compensated for vibrations and used to modify the array beam pointing angle.

In some other embodiments, the system is a platform including a plurality of MEMS IMUs coupled to sensor elements, and a controller configured to measure the position and/or attitude of each sensor element, to determine the phase shift to apply to the individual sensor elements.

In accordance with another aspect, a “virtual system IMU” (VSIMU) is provided, the VSIMU being formed by a plurality of MEMS IMUs, each mounted on, or in close proximity to, one or more individual sensor elements. In some embodiments, the sensor system can be non-localized, and the sensor elements may be distributed, such as on unmanned vehicles thus allowing the formation of a virtual or distributed array.

In accordance with another aspect, an improved sonar or radar is provided, for which each sensor element is provided with a MEMS IMU mounted thereon, each MEMS IMU being in communication with a controller configured to determine the position and/or attitude of each sensor element. Alternatively, a selected group or subsets of sensor elements can be actuated as a subarray wherein each subarray is associated with a selected inertial measurement unit.

### BRIEF DESCRIPTION OF THE DRAWINGS

FIG. 1 is an illustration of an airborne sensor platform with a strapdown IMU affixed to an aircraft with an INS with a separate INU.

FIG. 2A is a schematic representation of a desired wavefront generated by a phased array system. FIG. 2B is a schematic representation of a distorted wavefront resulting from uncorrelated motion of the individual sensor elements.

FIGS. 3A to 3C are schematic representations of two of the sensor elements, undistorted positions, (b) displaced along the array normal by linear vibration; and (c) displaced angularly by torsional effects.

FIG. 4A is an exemplary embodiment of a sensor array, in this case an Active Electronically Steered Array (AESA) Radar. FIG. 4B is a schematic representation of the radar of FIG. 4A, showing the T/R modules in reference to the antenna aperture held in relative position by a mechanical manifold.

FIGS. 5A and 5B are schematic illustrations showing another embodiment of a sensor array, in this case a Synthetic Aperture Radar (SAR).

FIGS. 5C and 5D are schematic illustrations showing other further embodiments of a sensor array, in this case a multi-beam SONAR and a towed SONAR array.

FIGS. 5E-5N illustrate further embodiments including LiDAR with integrated MEMS sensors and multi-modal autonomous control and collision avoidance for robotic vehicle navigation.

FIG. 5E illustrates a multimodal sensor system including LiDAR for an autonomous vehicle.

FIG. 5F illustrates the distribution of the array of sensors on the autonomous vehicle.

FIG. 5G illustrates an example LiDAR system including an array of emitters.

FIG. 5H illustrates an example LiDAR system including a single emitter.

FIG. 5I illustrates an example LIDAR system including an emitter lens according to various embodiments described herein.

FIG. 5J illustrates an array of LiDAR modules.

FIG. 5K illustrates an example LiDAR system including an inertial sensor in accordance with various embodiments described herein.

FIG. 5L illustrates an example LiDAR system including an inertial sensor in accordance with various embodiments described herein.

FIG. 5M illustrates a 3DS MEMS IMU architecture.

FIG. 5N illustrates an example LiDAR system including an inertial sensor in accordance with various embodiments described herein.

FIG. 6 is a further embodiment of a sensor element, here a single T/R module provided with a MEMS IMU in a typical radar transmit/receive (TR module).

FIG. 7 is a schematic representation of an active phased array radar in which at least some of the sensor elements are associated with MEMS IMUs.

FIG. 8 is a schematic representation of a further embodiment of a system for detecting and determining the motion of sensor elements using MEMS IMUs.

FIG. 9A is a three dimensional (3D) MEMS IMU, which can be coupled with the sensor element of a sensor system with the system clock function provided through the I/O port.

FIG. 9B is a schematic representation of a further embodiment of a MEMS IMU.

FIG. 9C is a schematic representation of a further embodiment of a MEMS IMU with the individual clock function provided by a MEMS clock on the MEMS chip.

FIG. 9D is a schematic representation of a further embodiment of a MEMS IMU with the individual clock function provided by a MEMS or quartz clock on the IC chip.

FIG. 9E is a schematic, cross-sectional view of an integrated MEMS system, according to another embodiment. FIGS. 9F and 9G are detail views of insulated conducting pathways formed in the MEMS chip, showing two variants. FIG. 9H is a schematic, cross-sectional view of an integrated circuit wafer. FIG. 9I is a schematic, cross-sectional view of a MEMS wafer stack. FIG. 9J is a schematic, cross-sectional view showing wafer-level flip bonding of the integrated circuit wafer of FIG. 9H to the MEMS wafer stack of FIG. 9I. FIG. 9K is a schematic, cross-sectional view of the integrated MEMS system of FIG. 9E, bonded to a printed circuit board (PCB).

FIG. 9L is a schematic cross-sectional view of an IC wafer and two MEMS wafer stack, bonded at the wafer level. FIG. 9M is a schematic, cross-sectional view of an integrated MEMS system, according to a possible embodiment, shown bonded to a PCB.

FIG. 9N is a schematic cross-sectional view of a MEMS wafer stack and of several IC chips, bump bonded to the MEMS wafer stack. FIG. 9O is a schematic, cross-sectional view of an integrated MEMS system, according to another embodiment, shown bonded to a PCB.

FIG. 9P is a process flow diagram illustrating a method of operating a MEMS transducer device in accordance with preferred embodiments of the invention.

FIG. 9Q is a process flow diagram illustrating a method of operating a proof mass MEMS device in accordance with preferred embodiments of the invention.

FIG. 10 is a schematic block diagram illustrating a phase adjustment procedure based upon a plurality of MEMS IMUs and a sensor platform IMU.

FIG. 11 is a schematic block diagram illustrating a phase adjustment procedure based upon an array MEMS IMUs and a navigation system INS, and optionally eliminating the platform IMU.

FIG. 12 is a schematic block diagram illustrating a phase adjustment procedure based upon an array of MEMS IMUs with system GPS and GNSS, eliminating the central system INU.

FIG. 13 is a schematic block diagram illustrating a phase adjustment procedure based upon an array of MEMS INUs (MEMS IMUs, each with its own GPS and GNSS), eliminating the central system INU.

FIG. 14 is a schematic representation of a further embodiment of a non-localized sensor system representing a distributed virtual array, here a swarm of Unmanned Air Vehicles (UAVs), enabled by MEMS IMU-equipped elements in each individual platform, communicating via a communications system, whether RF or optical, and of any topology, whether point-to-point, star, ring, tree, hybrid, daisy chain, or other.

FIG. 15 is a schematic representation of a further embodiment of a non-localized sensor system representing a distributed virtual array, here a swarm of Unmanned Underwater Vehicles (UUVs), each enabled by a MEMS IMU-equipped element, communicating via a communications system which can be acoustic.

FIG. 16 illustrates a towed receive array sonar system.

FIG. 17 illustrates various antenna reflector configurations with antenna regions having MEMS IMUs mounted on each region.

FIG. 18 illustrates an incident wavefront on a plurality of radar antennas.

FIG. 19 illustrates the phase front of a plane wave.

FIG. 20 illustrates an example of a satellite system using distributed MEMS IMUs.

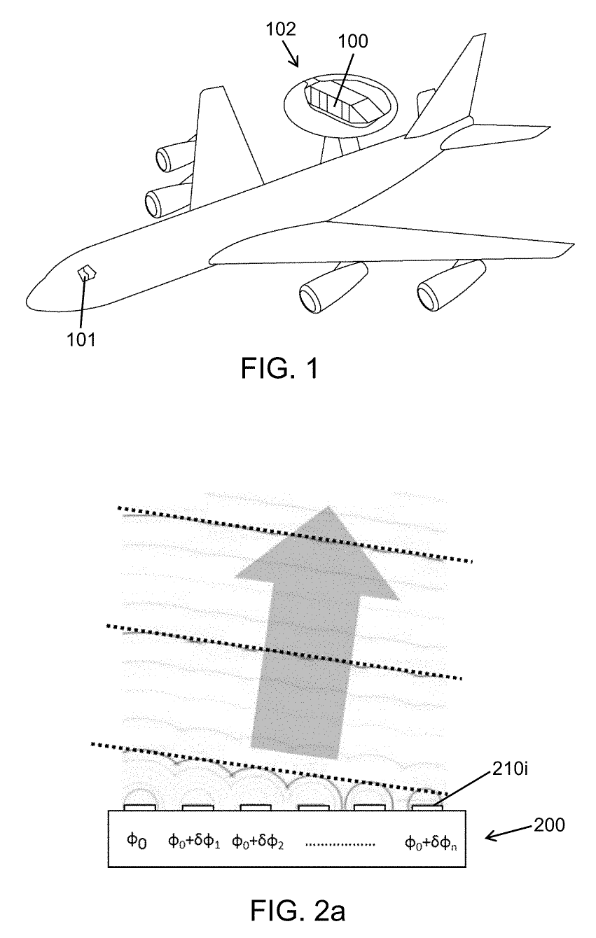

### DETAILED DESCRIPTION

Radars and sonars, particularly airborne or seaborne radars with advanced features including Electronically Scanned Arrays (ESA), Synthetic Aperture Radars (SAR), Inverse Synthetic Aperture Radars (ISAR), Ground Moving Target Indicator (GMTI), Coherent Change Detection, and Synthetic Aperture Sonar (SAS) benefit from precise motion detection. Tracking sensitivity and accuracy are limited by uncertainties in platform and element velocity changes (acceleration). Platform roll, pitch, and yaw introduce additional pointing angle and Doppler spreading errors across the face of the array.

It is desirable to be able to measure the distortion, both linear and angular (displacement and torsion), for at least some of the sensor elements, and if possible at each sensor element, to correct the phase shift errors and reconstruct the desired wavefronts. Microelectromechanical Systems (MEMS) accelerometers and gyroscopes are attractive from a SWAP standpoint as they are small and inexpensive, and can enable multiple inertial sensors to be distributed across the array of sensor elements to determine, monitor or compensate the motion of the elements.

Although attractive from a SWAP perspective, MEMS accelerometers and gyroscopes have historically been noisy, building up position errors rapidly. The sensitivity of accelerometers and gyroscopes is limited by bias instability. Bias instability is a measure of the random noise generated by the inertial sensor and is the minimum uncertainty in the output signal of the device. For very expensive navigation grade sensors (e.g. based on fiber optic gyroscopes (FOGs) like the Honeywell HG-9900), the bias instability is on the order of 3 millidegrees/hour for the fiber optic gyro and 10 micro-g (0.1 mm/sec²) for the accelerometer. An industrial grade MEMS IMU (e.g. Bosch BMX055) can have a gyro bias instability of around 10 deg/hr and an accelerometer bias instability of around 100 μg (1 mm/sec²). Thus, MEMS sensor errors can build up much more quickly. Since MEMS gyroscopes measure angular rate, attitude errors (or angular errors) grow linearly with time. Errors in position calculated from MEMS accelerometers grow quadratically.

A new generation of MEMS IMU, referred to herein as a “3DS MEMS IMU”, has lower bias instability, such as an angular rate bias instability less than 1 deg/hr, and preferably less than 0.1 deg/hr, and more preferably less than 0.01 deg/hr, and/or an accelerometer bias instability less than 100 μg, and preferably less than 10 ug, and more preferably less than lug, without sacrificing SWAP, since they can be as small as 0.1 cm³ and weigh as little as 1 gram per unit. These 3D MEMS IMUs incorporate one or more thick inertial proof masses suspended from springs and free to move in 3 dimensions between electrodes in top and bottom caps which form, with the MEMS, a hermetic low pressure chamber. The resulting high quality factor resonance, coupled with the large masses give rise to mechanical noise and bias instability that are much lower than that of previous MEMS IMUs, which use 2D comb capacitor drive and sensing, requiring the use 5 of thinner masses. These 3DS MEMS IMUs are constructed all of conductive silicon, so the hermetic chamber also provides protection against temperature effects such as differential thermal expansion and against rf interference. Thus one or more 3D MEMS IMUs can be integrated into some or each of the sensor elements of remote sensing systems, (such as sonars and radars), giving detailed local motion information (vibration and torsional movements) about the transmit and receive surface for phase and pointing accuracy. Furthermore, the data from the plurality of MEMS IMUs can provide hundreds or thousands of motion data points, providing detailed motion information regarding the behavior of the aperture throughout the range of physical and thermal loading and allowing enhanced range and azimuth resolution beyond those possible today with a single high SWAP navigation IMU. While is it preferred to use 3D MEMS IMUs, it is possible to use other types of MEMS IMUs, provided their specifications (i.e. bias instability) allow for it. Examples of MEMS devices for the fabrication of these MEMS IMUs are described in U.S. Pat. No. 9,309,106 issued on Apr. 12, 2016, and U.S. application Ser. No. 14/622,548, filed Feb. 13, 2015 and Ser. No. 15/024,704, filed Mar. 24, 2016, the entire contents of the above referenced patents and applications being incorporated herein by reference.

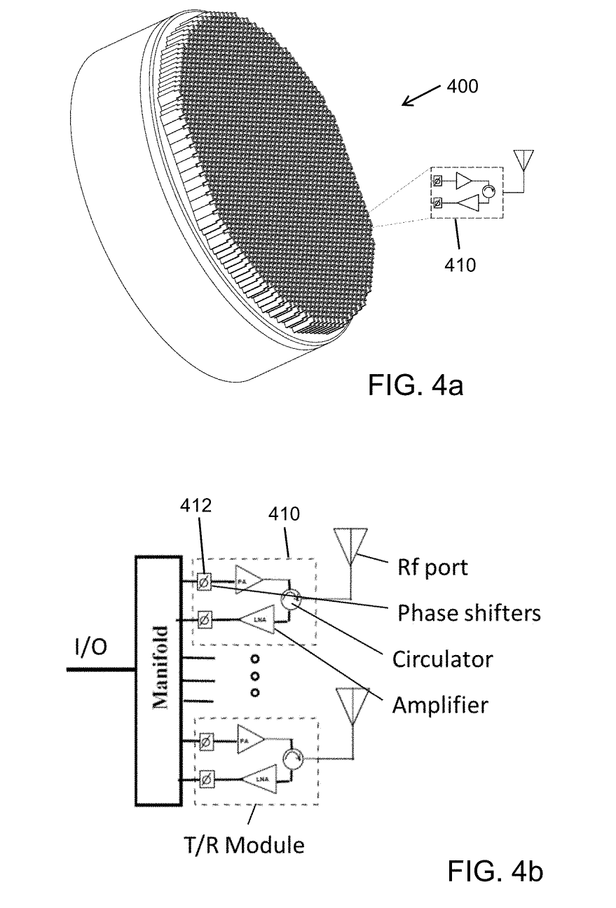

FIGS. 4A and 4B show an exemplary system, a phased array radar, in this case an actively electronically steered array (AESA) 400. An AESA radar is a radar in which the transmitting power is produced by a plurality of sensor modules 410, which in this case are T/R modules, allowing the radar to electronically scan position and frequency and often capable of producing a narrowly focused, rapidly steered beam with low sidelobes that is less easy to detect and jam.

FIG. 4A shows the array of T/R modules that form the face of the AESA. An active phased array typically uses solid state transmit and receive modules, where all components are assembled in one single T/R module. A T/R module can include a phase shifter, an attenuator, a power amplifier, a low noise amplifier (LNA), a pair of circulators and a duplexer. The T/R module can of course include other functional circuits. FIG. 4B illustrates a subunit of the AESA showing several T/R elements, each with its own base shifter 412.

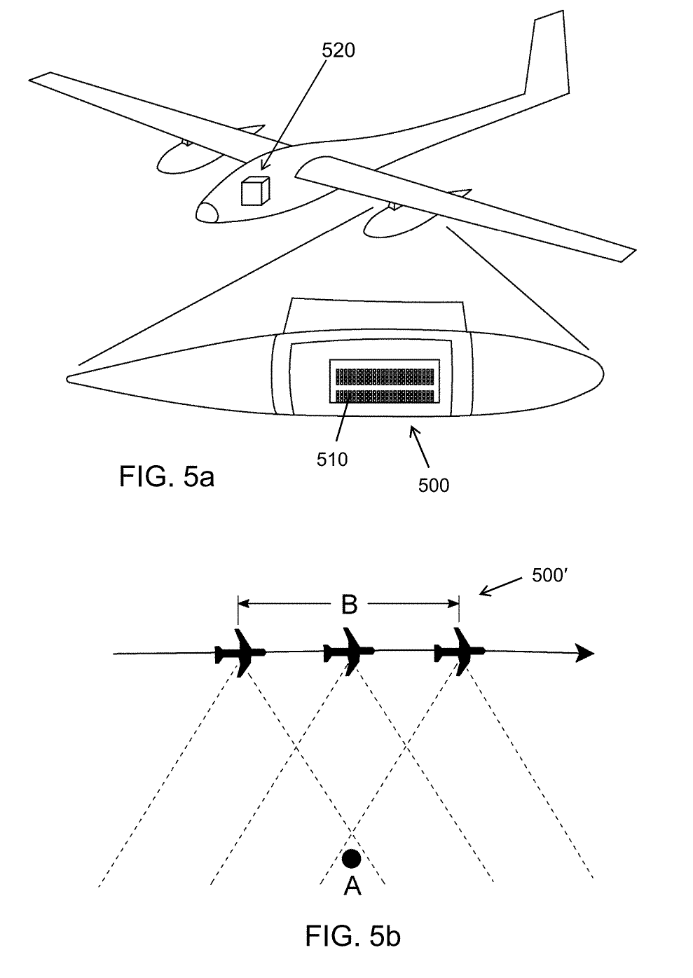

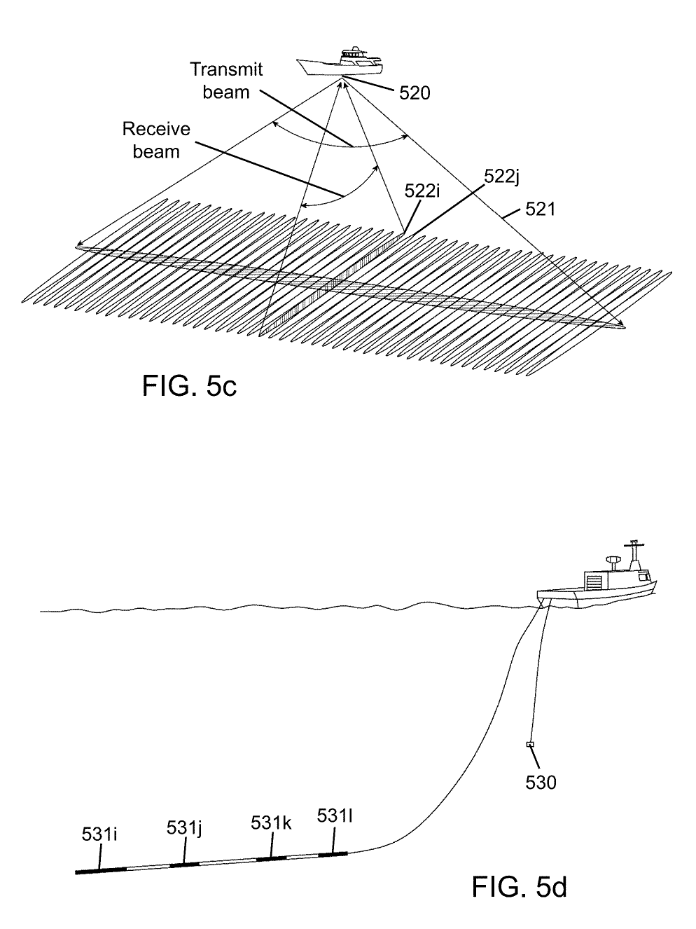

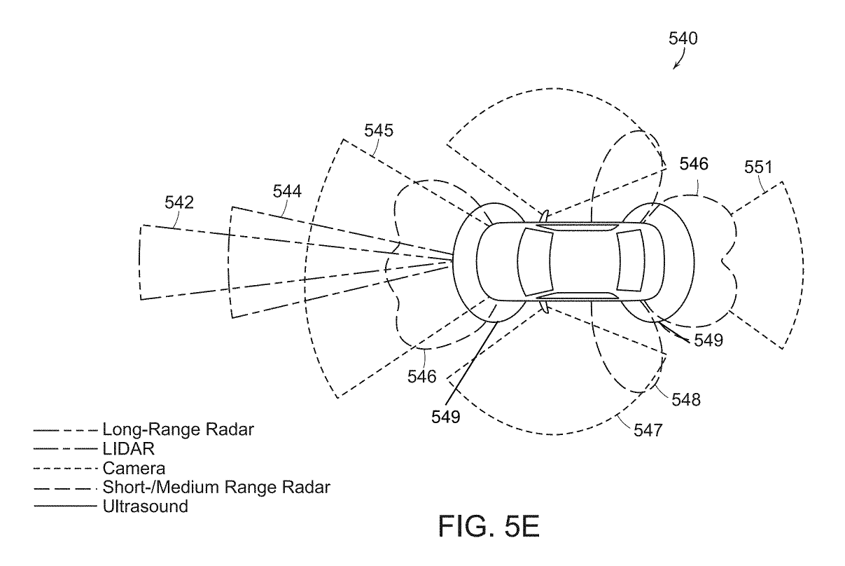

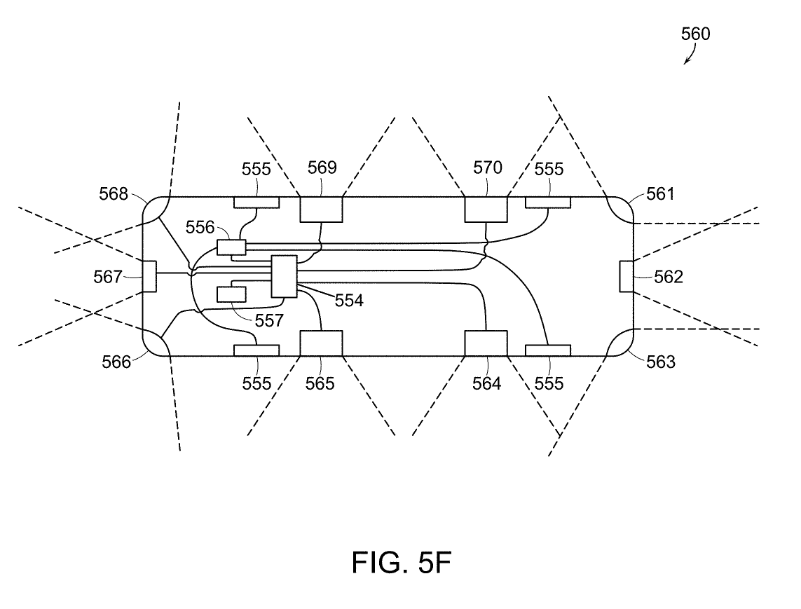

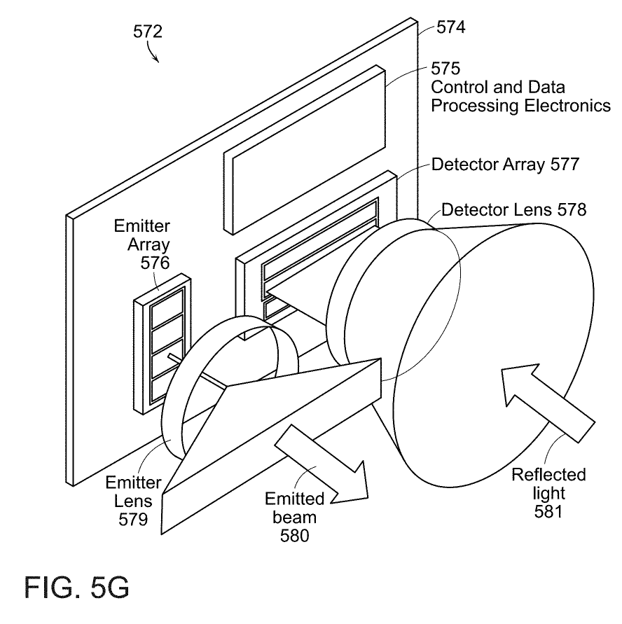

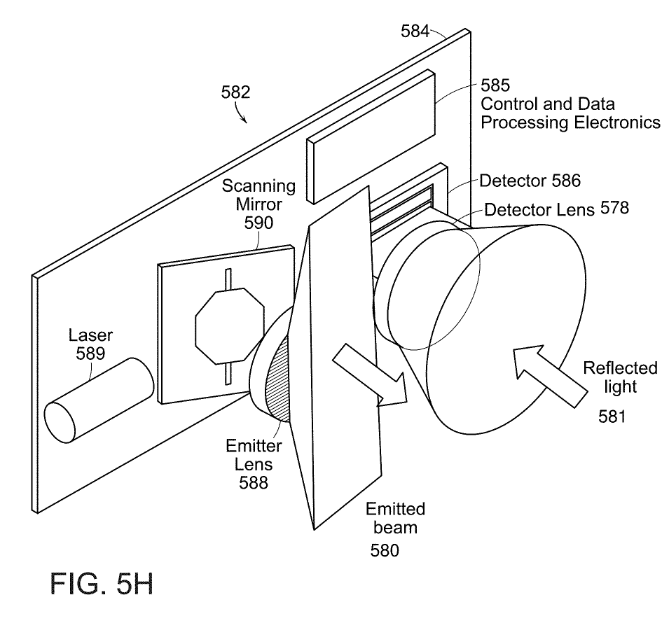

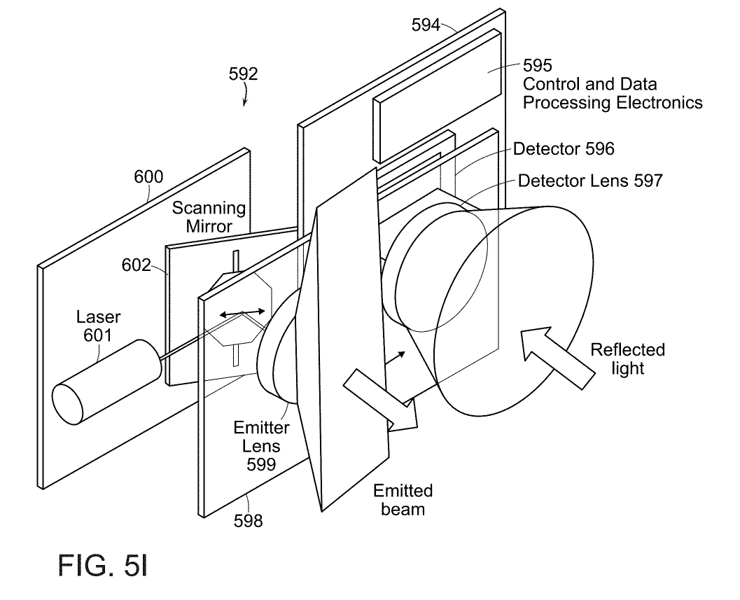

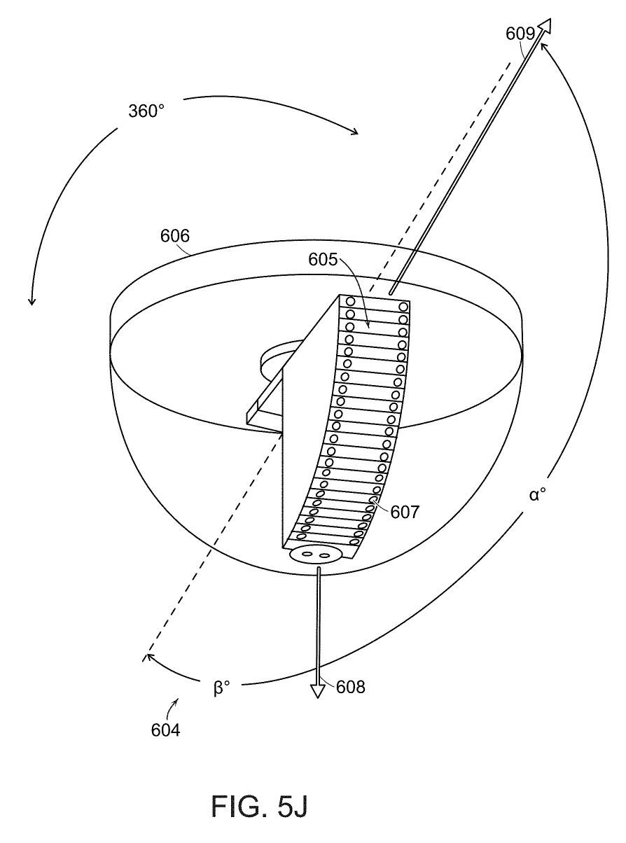

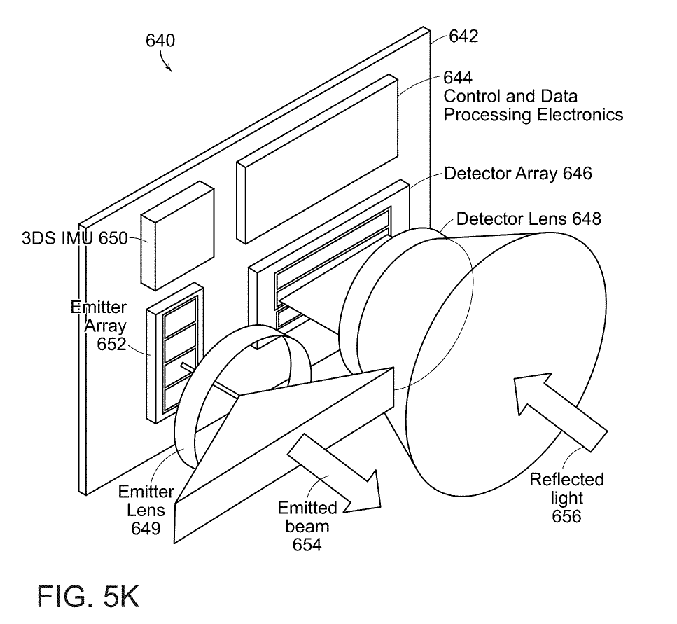

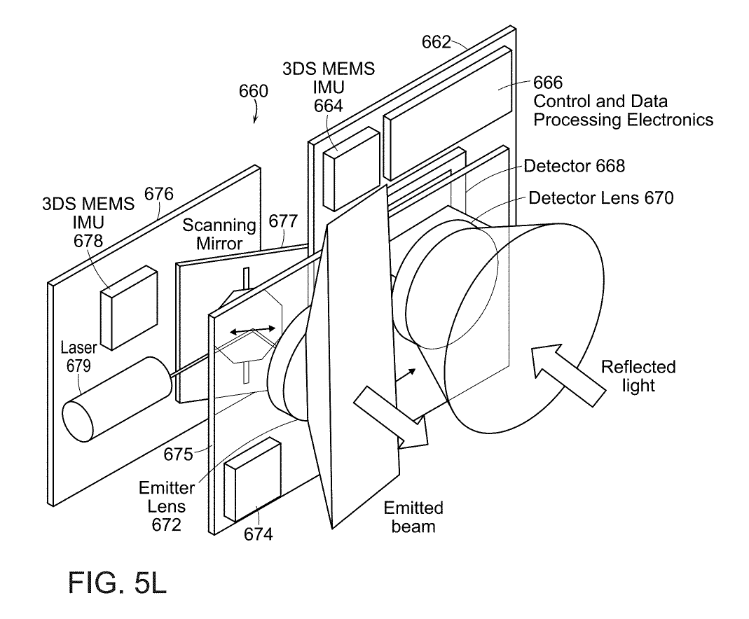

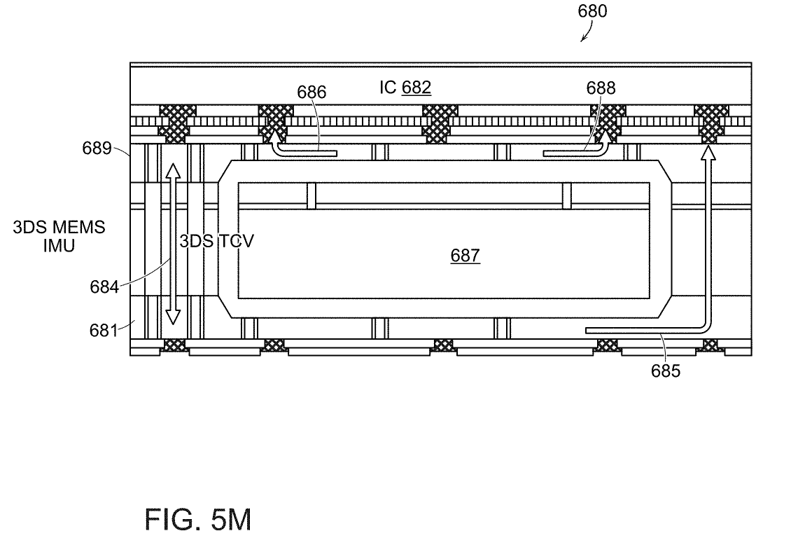

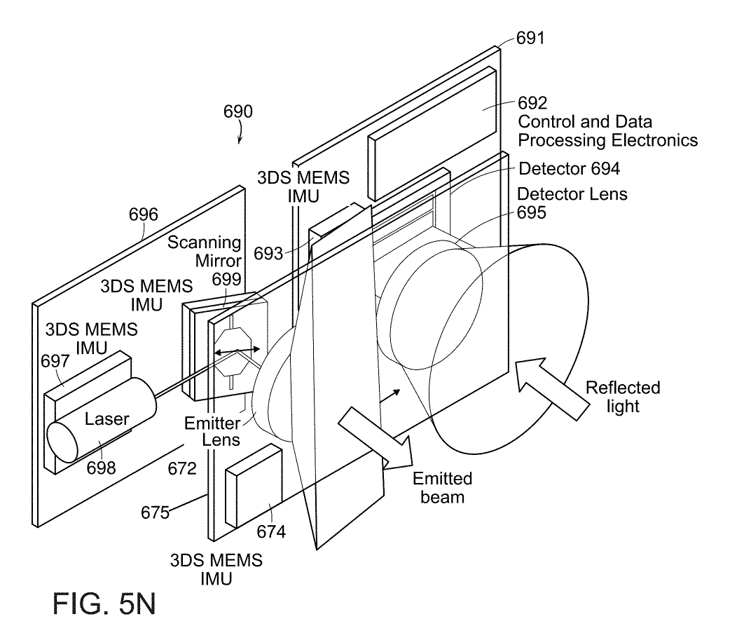

Another exemplary sensor array is a Synthetic Aperture Radar (SAR) 500 as shown in FIGS. 5A and 5B. The SAR unit can have one or more sensor elements 510. FIG. 5A shows a SAR based on a phased array radar. What differentiates the SAR is that its position changes over time. Referring to FIG. 5B, by processing the returns from the target (A) for the entire time, it is illuminated by the beam, a short antenna can operate as if it was much longer (B) than its actual length, providing improved spatial resolution.

While the two examples provided above are based on radar technology, the principle of the present invention can also be used in sonar systems, or any detecting and/or positioning systems comprising a plurality of sensing and/or emitting elements, such as T/R modules. For example, referring to FIG. 5c, multi-beam sonars 520 are used to plot sea bottom topology by using a transmitted acoustic beam 521 that is narrow along the ship track and wide across track. There are many received beams 522i, 522j, but each is long along track and narrow across track. The intersection of the transmit beam 521 and individual receive beams 522i provides the depth information at that point. It is necessary to know the position and attitude of the acoustic transmit and receive modules in time to accurately map the sea floor, Referring to FIG. 5D, towed sonar arrays have a towed transmitter 530 and a separate array of towed receivers 531i-l. All are mounted on flexible cables that can move relative to each other. Again it is necessary to know the positions and attitudes of the transmitters and receivers relative to each other and to their position in the ocean.

The present invention is especially adapted for use in object-detecting systems, which are used to determine at least one of the range, angle and velocity of a target. Broadly described, the present invention is concerned with the mounting of MEMS IMUs, and particularly 3DS MEMS IMUs, onto individual sensor elements or subarrays of such sensor elements of position-detecting system. Given their small size, weight and reduced power consumption, and provided they allow for a minimal bias instability, such as below 1 deg/hr, MEMS-based IMUs including accelerometer and angular rate sensors (6DOF MEMS IMUs) can be mounted directly on some, and preferably on each, sensor element. The measurement signals of the MEMS IMUs can be processed directly at the sensor element, by the MEMS processing circuitry or by the sensor element processing unit, or they can be sent to a central processing unit allocated for a sub-set of the sensor elements.

LiDAR (Light Detection and Ranging) is rapidly becoming a key element in ADAS (Advanced Driver Assistance Systems) and autonomous vehicle navigation. LiDAR was developed for survey and mapping. It can produce very accurate 3D measurements of the local environment relative to the sensor. This accuracy is achieved by the emission of thousands of pulses of laser light per second and the measurement of the time of flight (TOF) between emission and the collection by a sensor of the reflected light from the environment.

Shown in FIG. 5E is a multimodal sensor system for an autonomous vehicle 540 wherein forwarding looking sensors include a camera field of view 545 for traffic sign recognition, LiDAR field of view 544, longer range radar FOV 542, and optional shorter range radar FOV 546 and ultrasound 549 that looks in both forward and rear directions for close proximity warning. Side camera 547 and rear side looking radars 548 and camera 551 can also be used.

Thus, the array of modules on different sections of a wheeled ground vehicle or automobile can have selected combinations of sensors. A forward looking module is preferably configured with a plurality of sensors operating in different modes such as a radar emitter and detector, one or more cameras, a LiDAR sensor, and an ultrasound sensor which can operate to sense obstacles at different ranges. Sensor fusion programs can be used by the processor 554 to simultaneously process data from each of the plurality of sensors and automatically send navigation and control commands to the braking and steering control systems (described below) of the vehicle 540. Simultaneous location and mapping (SLAM) programs have been extensively described in the art such as, for example, in U.S. Pat. Nos. 7,689,321 and 9,945,950, the entire contents of these patents being incorporated herein by reference.

The sensor array distribution is seen in FIG. 5F for autonomous vehicle 560 operated on wheels 555 with the array of sensor modules 561-570 distributed around the vehicle and connected to processor 554. Each of the sensor modules 561-570 can perform one or more sensing functions as described above including acquiring a camera FOV 545, 547, 551, LiDAR FOV 544, long range radar FOV 542, 548 short/medium range radar FOV 546, or ultrasound 549. Each sensor module 561-570 can send ranging data to or receive instructions from the processor 554 in various embodiments. The wheels 555 include brakes. The brakes can include sensors that detect data related to the wheel 555 or brake status (e.g., wheel revolutions per minute, brake actuation status, percentage of braking applied). The brake sensors are operatively coupled to a braking module 556 that is in communication with the processor 554. The braking module 556 can receive data related to the wheel 555 or brake status and can selectively control the brakes stop the autonomous vehicle 560. The processor 554 can control the braking module 556 to apply the brakes based upon an analysis of ranging data received from the array of sensor modules 561-570 to enable the autonomous vehicle 560 to avoid collisions with objects.

The autonomous vehicle 560 can also include a steering module 557 that is in communication with the processor 554. The steering module 557 can control a steering mechanism in the vehicle to change the direction or heading of the vehicle. The processor 554 can control the steering module 557 to steer the car based upon an analysis of ranging data received from the array of sensor modules 561-570 to enable the autonomous vehicle 560 to avoid collisions with objects.

Two types of LiDAR systems are shown in FIGS. 5G and 5H. A LiDAR system 572 includes an emitter and a detector. The LiDAR system 572 can be one of the sensor modules 561-570 as described above with respect to FIGS. 5E and 5F. The emitter 576 can be a light emitter in some embodiments. The detector 577 can be a light detector or an array of light detectors in various embodiments. The emitter 576 can be an array of emitters 576 (such as laser diodes) as in FIG. 5G or a single laser 589 as in FIG. 5H. Depending upon the details of each system, the emitted light 580 is spread out into a cone of emitted light 586. The emitted light 586 can be reflected by objects in the environment surrounding the autonomous vehicle. The reflected light 581 is received at a detector lens 578 that focuses the light onto the detector 586. For an array of emitters 576 (FIG. 5G), the lasers can be sequentially pulsed and spread out by optics (e.g., emitter lens 579) into a two-dimensional beam. The sequential pulsing of the emitters in the array 576 can create a vertical scan effect.

For a single emitter 589 (FIG. 5H) as in the system 582, the pulse is bounced off a scanning mirror 590 that oscillates along one axis, and the beam is spread out along a second, orthogonal axis by a diffusing emitter lens 588. The scanning mirror 590 can be a rotating galvanometric mirror or a MEMS (MicroElectroMechanical Systems) mirror.

In systems 572, 582, the emitted beam 580, 586 is reflected by the various objects in the vicinity of the sensor and a portion of the reflected beams 581 are collected by the detector (or collector) lens 578 and focused onto a detector array 577, 586. The detector array 577, 586 can be a 2D or 3D array and can include many photodetectors such as photodiodes. The time of flight (from emission to collection) of each of the beams is measured precisely by the control and data processing electronics 575, 585 using the data received from the detector array 577, 586. In this way a “point cloud” is built up wherein the distance to each point in the point cloud is accurately recorded. This point cloud is a representation of the LiDAR system's environment.

The LiDAR system 572, 582 can include control and data processing electronics 575, 585 in some embodiments. The control and data processing electronics 575, 585 can send data to and receive instructions from the processor 554. The control and data processing electronics 575, 585 can receive data from the detector 557, 586. The control and data processing electronics 575 can control the status and sequencing of emitters in the array of emitters 576. The control and data processing electronics 575 can control the deflection angle of the scanning mirror 590. In some embodiments, the control and data processing electronics 575, 585 can send raw data from the detector 577, 586 to the processor 554. In some embodiments, the processor 554 can include a global positioning system (GPS) sensor. In some embodiments, the control and data processing electronics 575, 585 can perform initial processing on the data received from the detector 577, 586 and send the processed data to the processor 554. In some embodiments, the control and data processing electronics 575 can include a steering circuit to adjust an orientation of the system 572, 582.

In some embodiments, the components of the LiDAR system 572, 582 can be mounted to a single backplane 574. For example, the backplane 574, 584 can be a printed circuit board (PCB). Additional PCBs can be added to the sensor modules on the vehicle that include other sensor modes such as radar and/or imaging cameras, for example. These sensors can also include co-located inertial sensors to compensate for sensor motion relative to the vehicle's frame of reference as described herein.

Because the speed of light is so high, the individual pulses of light are very short, on the order of a few hundred picoseconds and the time of flight is a few microseconds. Thus, an individual measurement is very accurate, to within a few cm (e.g. less than 5 cm). This enables the LiDAR system to build up a 3D map of its environment over many scans. Typically the scan or frame rate is on the order of a few tens (e.g. 10-100) of Hertz.

The LiDAR system's 3D map of the local environment is useful for identifying driving hazards such as other vehicles, pedestrians, etc. However, the vehicle upon which the LiDAR is mounted is typically moving, which complicates the mapping. The LiDAR can only measure relative distance between the vehicle and the hazard. Thus, it is important to also know the absolute geographical position of the LiDAR to accurately build up a map of the environment, complete with stationary and moving objects.

For static LiDAR applications such as surveying and mapping, GPS (Global Positioning System) data is sufficient to provide geographic location. However, it is not sufficient for a moving vehicle. The GPS receiver needs to have a clean line of sight (LOS) to at least four GNSS (Global Navigation Satellite System) satellites to obtain longitude, latitude and altitude coordinates. There may not always be direct LOS because of satellite positioning or because of obstruction of the LOS by buildings, trees, or other obstructions. Even with no obstructions, the position update rate is less than 10 Hz, which is too slow for a moving vehicle. Additionally, the LiDAR needs velocity and attitude information to accurately navigate the driving hazards.

In most navigation systems using LiDAR, GPS data is augmented by the vehicle Inertial Navigation System (INS) data. However, accuracy costs money. For defense or geodetic survey systems, an expensive Inertial Measurement Unit (IMU) can be used. These typically use expensive (thousands of dollars) accelerometers and Fiber Optic Gyroscopes (FOGs) for motion data. This cost is generally not viable for most automotive applications, so typically MEMS IMUs are used. These IMUs, while much cheaper, are much less accurate and can drift a few meters in a few seconds. Nonetheless, they are used to “fill in the gaps” between GPS readings.

Another source of positional inaccuracy that has not been addressed at all is the relative position of the LiDAR system relative to the automobile INS and emitter(s) relative to the detectors within an individual LiDAR sensor. The first error assumes the emitter and detector are fixed relative to the vehicle INS. However, particularly over many frames of data, bumps, vibrations, pitch, and roll, can introduce time dependent errors of mm or cm in the calculated position of the LiDAR. Flexing and torqueing of the printed circuit boards (PCBs) on which the optical components are mounted can introduce additional relative position errors affecting the TOF measurements and reducing the accuracy of relative position measurements. Finally, in many systems the emitters, lenses, and detectors can be on separate boards which can shift, vibrate, and torque relative to each other (FIG. 5I).

As shown in FIG. 5I, system 592 employs elements on separate boards 594, 598 and 600. The use of separate boards or backplanes 594, 598, 600 can enable a more modular design wherein parts can be substituted without removing the entire system. In addition, post-mounting alignment can be performed to optimize emission and detection of light among the components of the system 592. The system can include a laser 601 and scanning mirror 602 on a first board 600. The light reflects from the scanning mirror 602 and passes through the emitter lens 599 mounted to a second board 598. The second board 598 can be a wall or container for the system 592 in some embodiments. The emitted beam passes out to the environment and reflects from objects in the environment. The reflected light is received by a detector lens 597 that focuses the light onto the detector array 596. The detector array 596 and detector lens 597 are mounted onto a third board 594. The control and data processing electronics 595 can operate as described above with respect to systems 572, 582. Although the control and data processing electronics 595 is depicted as located on the third board 594, it could be located on any of the boards 594, 598, 600. As described above, the downside to dividing the system among multiple separate boards is that shifting and vibration of the boards with respect to one another can introduce error in the final TOF measurement.

A limitation of staring LiDARs is the limited field of view as shown in FIGS. 5G, 5H and 5I. The systems 572, 582 and 592 can detect light within the field of view (FOV). In the example of system 572, the emitter array 576 directs light through the emitter lens 579 to emit a beam 580 across the FOV such that reflected light 581 is collected through detector lens 578 and detected at detector array 577. The field of view of a staring LiDAR is typically limited to a few tens of degrees in the vertical and horizontal, leaving much of the environment unmapped. System 582 employs a laser 589 and a scanning mirror 590 to generate emitted laser 580. Typically staring LiDARs are mounted to the front and rear of the vehicle 560.

In order to increase the field of view, one or more LiDARs 605 can be mounted to a rotating gimbal 606 to scan the array in more than one direction. FIG. 5J shows an array of LiDARs 605 being rotated around one axis 608. As the gimbal 606 rotates, an aim direction 609 sweeps through 360°. The array of LiDAR sensors or systems 605 can span an angle 604 of between 0 and 180°. Each LiDAR sensor 605 can include an emission lens and a detector lens 607 similar to those described above with respect to FIGS. 5G-5I. Similarly, a single LiDAR can be rotated along two axes.

A potentially less expensive approach to increasing the FOV is to mount multiple LiDARs around the vehicle. However, in both gimballed and multiple-LiDAR solutions multiple frames of data from different times, positions, and orientations are processed and optionally stitched together to obtain an accurate, comprehensive representation of the environment. It is necessary to know the position and attitude of each of the LiDAR systems when the data is collected.

FIG. 5K illustrates a LiDAR system 640 similar to the system 572 described in relation to FIG. 5G with the inclusion of an inertial sensor. In order to provide accurate position data of each LiDAR system 640, an inexpensive, but high-performance (i.e. tactical/navigation grade) IMU, for example a 3DS MEMS IMU 650, can be placed on each unit as shown in FIG. 5K. The 3DS MEMS IMU 650 can be mounted to the board 642 along with the emitter array 652, the detector array 646, and the control and data processing electronics 644. The system 640 can include the emitter lens 649 to broaden out the emission angle from the emitter array 652 and produce the emitted beam 654. The emitted light is reflected by objects in the environment. The reflected light 656 is received by the detector lens 648 which focuses the light onto the detector array 646. The 3DS IMU is small enough and inexpensive enough that it can be placed on each LiDAR system 640 in the vehicle 560, but provides much higher accuracy than typical automotive IMUs, comparable to FOG-based IMUs costing thousands of dollars more. The inertial data from the local

IMU plus GPS data can be incorporated into the optical TOF data by the control and data processing electronics 644 or processor 554 to accurately determine the geographic position of the environmental features detected by the detector array 646. Furthermore, the accuracy of the 3DS IMU enables multiple point clouds acquired by the same LiDAR unit and/or point clouds acquired by multiple LiDAR units to be more accurately stitched together to provide a higher resolution 3D map of the vehicle's environment. For gimbal mounted LiDAR units, the 3DS IMUs can provide real-time and accurate position and attitude of the individual LiDAR units 640.

3DS IMUs can also improve the performance of systems that include components mounted on multiple boards. In order to compensate for the relative motion of optical components on separate or flexible PCBs (or other boards or container walls) such as 662, 675 and 676 of system 660 in FIG. 5L, the low cost and small size of the 3DS IMU 664, 674, 678 enables an IMU 664, 674, 678 to be placed near each component of the system 660 to more accurately reflect the position of each component and provide additional precision to the TOF measurement. For example, the first 3DS IMU 664 can be placed near the laser emitter 679 on the first board 678. The second 3DS IMU 674 can be placed near the emitter lens 672 and detector lens 670 on the second board 675 (which can be a part of the container or enclosure for the system 660 in some embodiments). The third 3DS IMU can be placed near the detector array 668 on the third board 662.

The highest measurement accuracy for the position of any LiDAR component can be achieved when the IMU is in the exact position of the component. The 3DS MEMS IMU architecture 680 shown in FIG. 5M enables the stacking of the MEMS with an IC of any type (e.g., control electronics, other MEMS, photodetectors). The IC 682 and MEMS can be bonded together at the wafer level, or bump bonded at the chip level. Through Chip Vias 684, 685 (TCVs) enable routing of signals through and from the MEMS formed from silicon wafers 681 and 689 around proof mass 687 to the IC 682.

FIG. 5N illustrates a LiDAR system 690 wherein the 3DS IMUs are stacked beneath the optical components to achieve the highest level of accuracy. For example, the 3DS MEMS IMU 697 can be stacked beneath laser 698 to measure the laser's position as a function of time. Here, “stacked” refers to the fact that the 3DS IMU 697 is physically located between the laser 698 and the backplane or board 696. The 3DS IMU 697 can support the laser 698 in some embodiments. As described above with relation to FIG. 5M, the laser 698 can receive electrical power or control communication through the TCVs of the 3DS IMU 697 in some embodiments. The scanning mirror 699 is also mounted to the board 696. The 3DS MEMS IMU 693 can also be mounted in a stacked arrangement with the detector array 694 on the board 691. The detector array 694 can receive data and power through the TCVs of the 3DS IMU 693 as described above with relation to FIG. 5M in some embodiments.

The laser 698 can operate at one or more wavelengths and output power levels depending upon the ranging distances and FOV for that sensor. LiDAR can use various emission wavelengths in the range of 750 nm to 1600 nm and other wavelengths depending upon the application. See, for example, U.S. Pat. Nos. 7,541,588, 8,675,181, and 9,869,754, the entire contents of these patents being incorporated herein by reference.

Although the control and data processing electronics 692 is shown as mounted to the board 691 in FIG. 5N, it can be mounted to the board 696. The light emitted by the emitter lens reflects from objects in the environment. The reflected light is received by the detector lens 695 which focuses the light onto the detector 694.

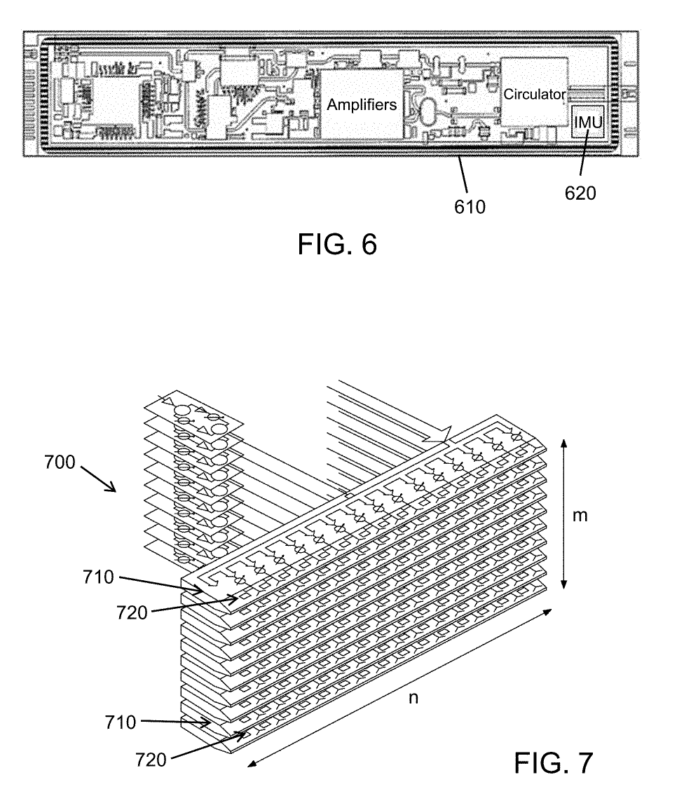

An exemplary embodiment of a sensor element 610, here a T/R module, having a MEMS IMU 620 mounted thereon is shown in FIG. 6. Typically the width of a T/R module is about half a wavelength. At 10 GHz, in the middle of the X-band, a half wavelength is 1.5 cm, which is 2-3 times the size of the IMU. The IMU can be mounted within the T/R module or on its exterior.

FIG. 7 illustrates an embodiment of a sensor array 700 with n×m sensor elements 710, each with an associated MEMS IMU 720. It should be noted that although a phased array radar is described herein, the procedure of using one or more MEMS IMUs at each sensor element is not limited to phased array radars, but to other electromagnetic and acoustic based imagers where the position of the transmitting or sensing element is important. These can include: linear or 2D arrays, transmit only modules or passive receive only modules, stationary phased array radars, synthetic aperture radars and sonars, and towed sonar arrays.

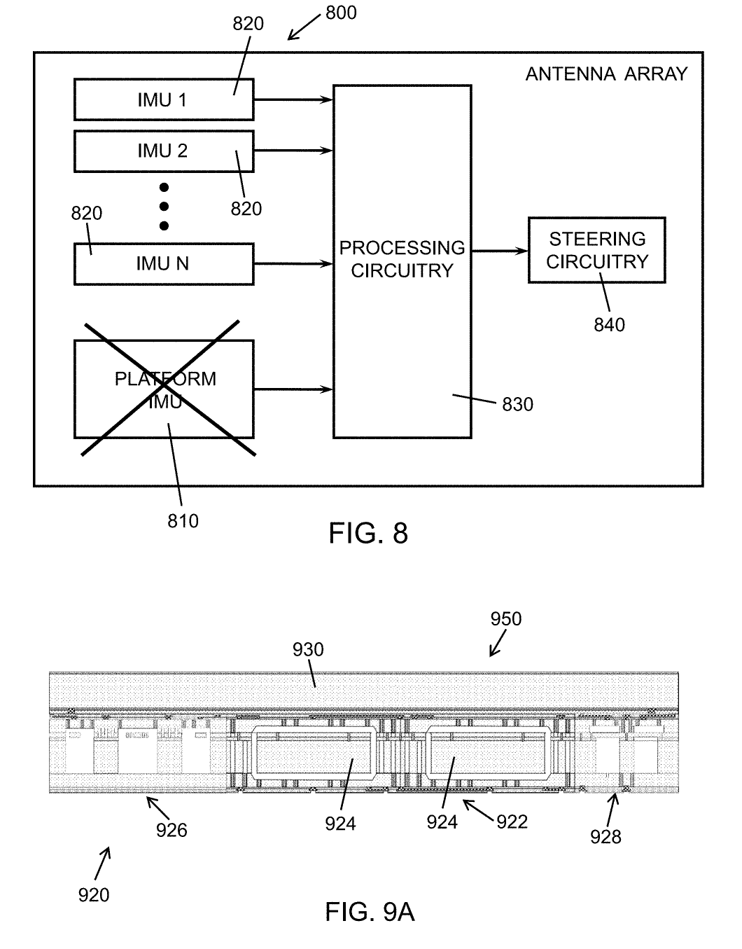

Referring still to FIG. 7, each IMU 720 comprises a 6DOF or higher motion sensor, able to acquire acceleration and angular rate data which includes local high frequency (typically 10->1000 Hz) vibrational and torsional motion as well as translational and rotational motion associated with the motion of the platform. The IMU measures the instantaneous position and angle of the module during pulse transmission, which can be only a few tenths of a microsecond or a few microseconds, as well as during the entire aperture time during which return data is being received. For these types of applications, the time of arrival of image data at the spatially separated sensor elements and IMUs is important, so accurate timing is essential. For a SAR, this aperture time can be several tens of seconds (i.e. 1 to >100 seconds). 3DS MEMS accelerometers and gyroscopes with lower bias drift enable longer aperture times, or longer times between sensor re-zeroing. For example, for X band radars, blurring occurs for motions of around 0.05 mm. A MEMS accelerometer with 100 μg bias instability can accrue position errors at a rate of around 1 mm/sec^{t}, while a 3DS IMU, for which the bias instability is typically less than 3 ug, would grow at only 0.03 mm/sec². The effect on pointing error is even more significant. Pointing accuracy of around 0.1 deg is desirable. The industrial gyro (10 deg/hr) reaches this limit in 36 seconds and thus cannot provide adequate pointing accuracy for longer aperture time. Consequently, MEMS gyroscopes have not been used in arrays. However, the gyroscopes in the 3DS MEMS IMU can provide this level of pointing stability for 40 minutes or longer, enabling the use of distributed MEMS gyroscopes for local pointing angle feedback. Still referring to FIG. 7, and also to FIG. 8, an additional advantage of using distributed 3DS MEMS IMUs with low bias drift is that their data can be combined to provide a “virtual system IMU” (VSIMU) 800, perhaps even replacing the very 15 expensive platform IMU 810. The virtual system IMU includes a system processor 830, a plurality of MEMS-based IMUs 820, with low bias instability, such as below 0.1 deg/hr and 3 ug, and an optional steering circuitry 840 to correct the orientation of each sensor element. The statistically averaged error from an ensemble of identical, but uncorrelated sensors is lower than that of an individual sensor by a factor of 1NN, where N is the number of sensors (N=rixm). So for large arrays, particularly those comprising thousands of elements, the averaged acceleration and angular rates of the ensemble can provide accuracy approaching that of an expensive FOG-based IMU. Once again, very accurate timing of the measurements at the spatially disparate IMUs is required to provide an accurate average of the N sensors as well as an accurate calculation of their individual instantaneous deviation from average. For example, a 1000 element array of 3DS IMUs could have ensemble biases of about 100 ng for acceleration and 5 mdeg/hr for angular rate. These bias instabilities approach or exceed those of the expensive IMU at a substantially lower cost and reduced weight. Also, the distributed network of MEMS IMUs in an array can operate in a degraded mode, providing greater reliability and accuracy, even with a significant number of the individual MEMS IMUs' performance degraded or disabled. A conventional IMU incorporates a single point failure flaw. If the single conventional IMU fails or is degraded, all dependent systems will fail or be degraded.

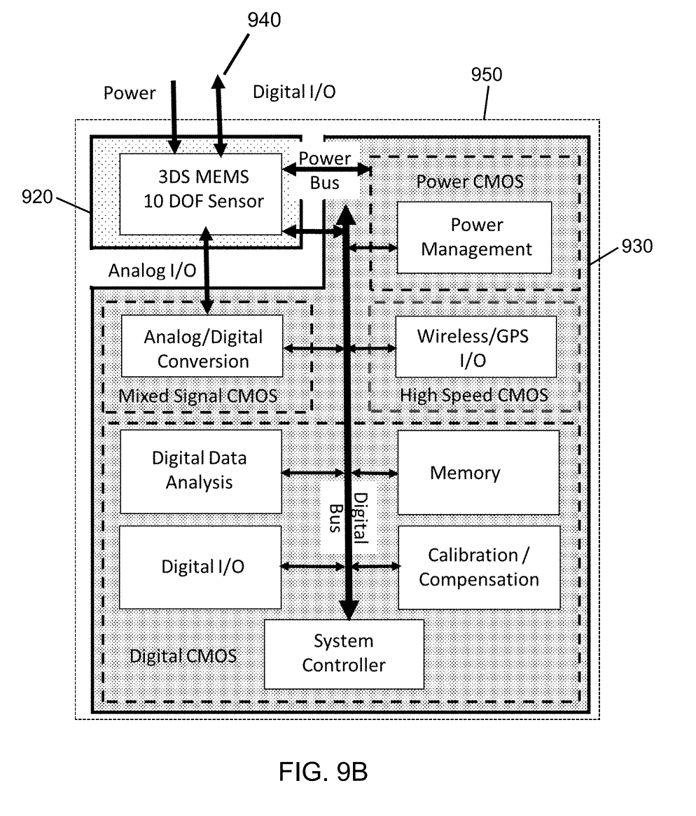

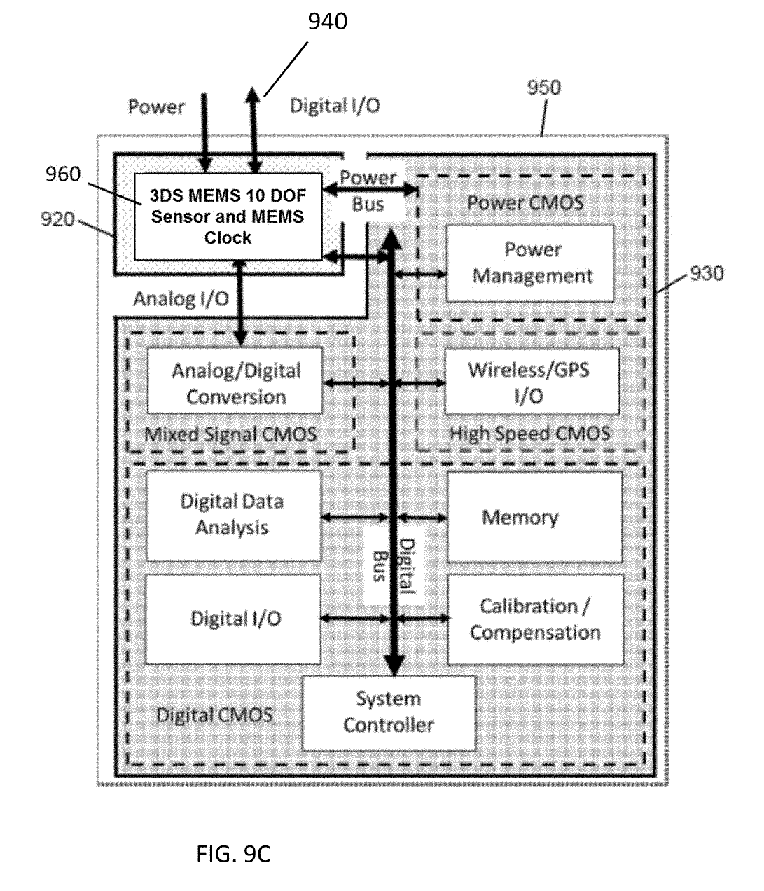

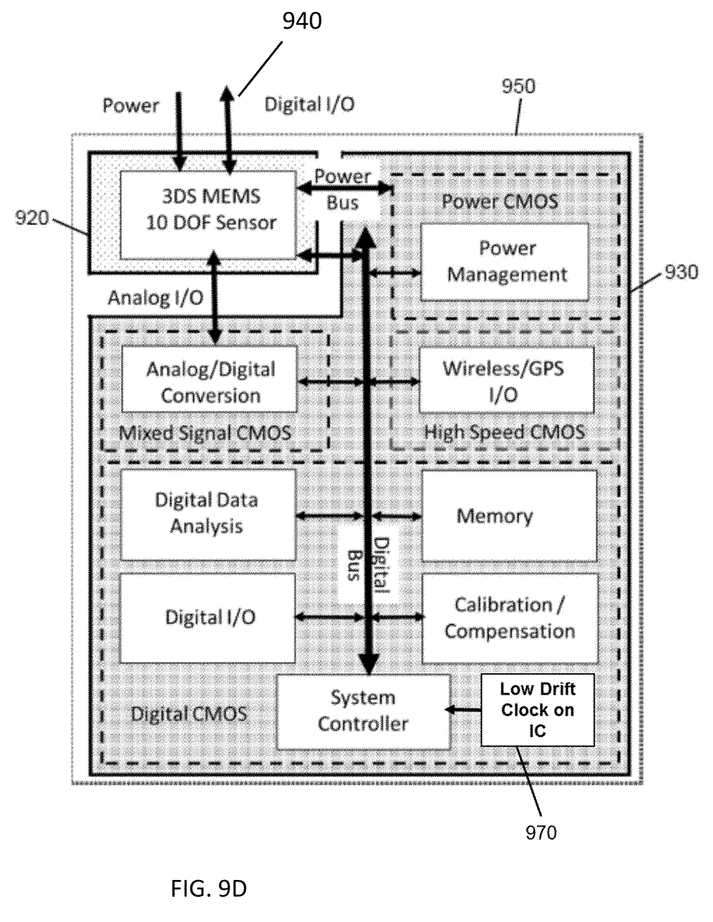

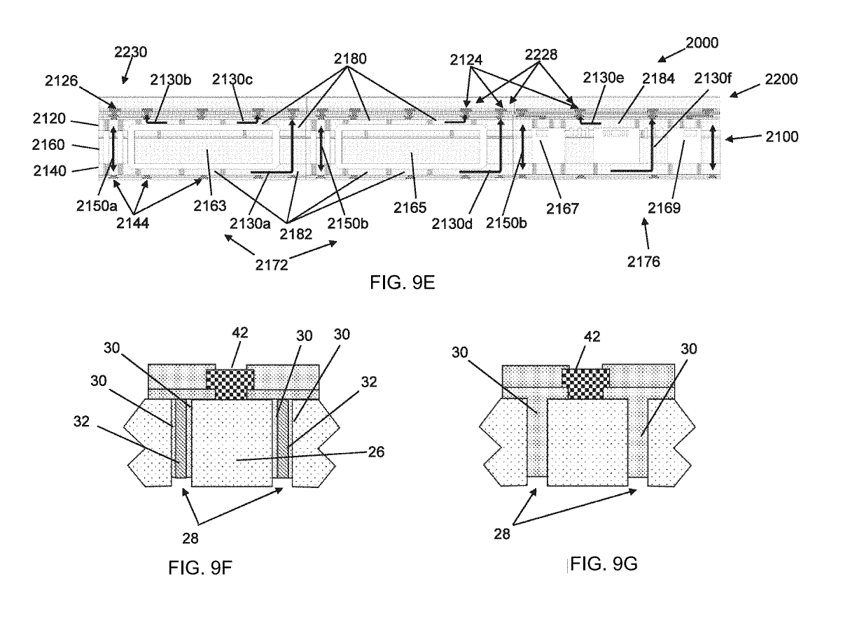

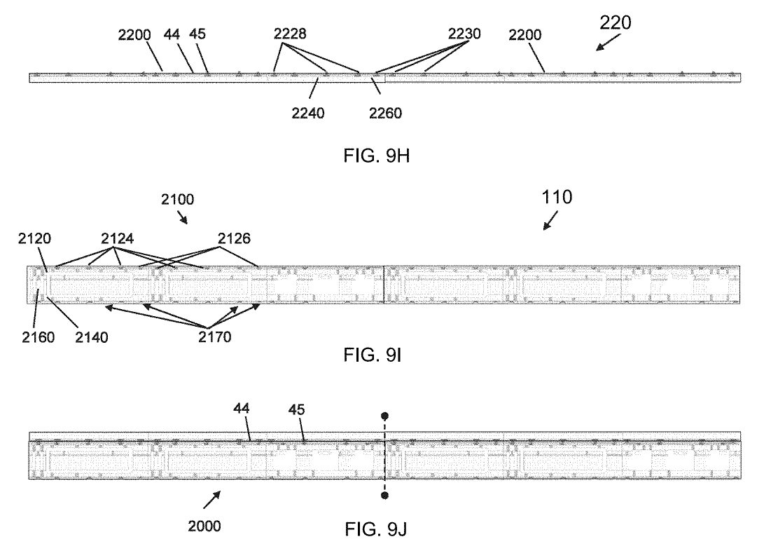

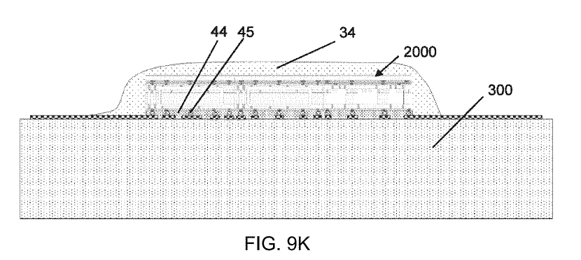

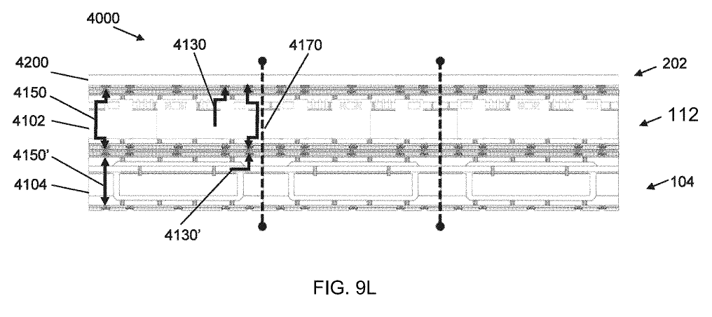

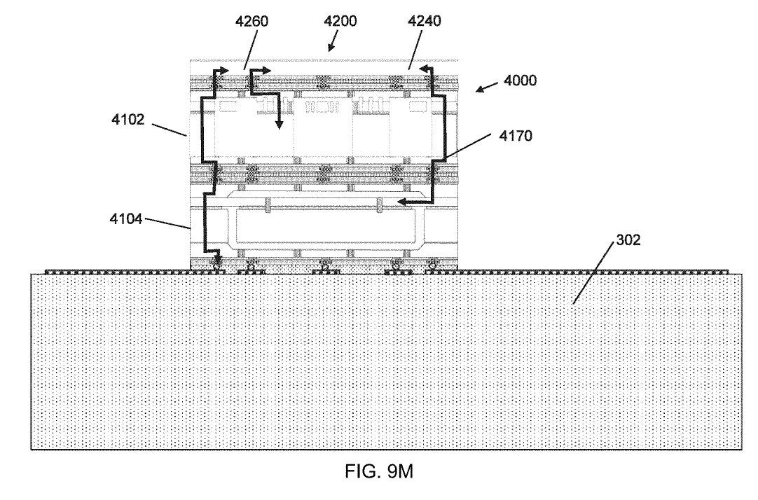

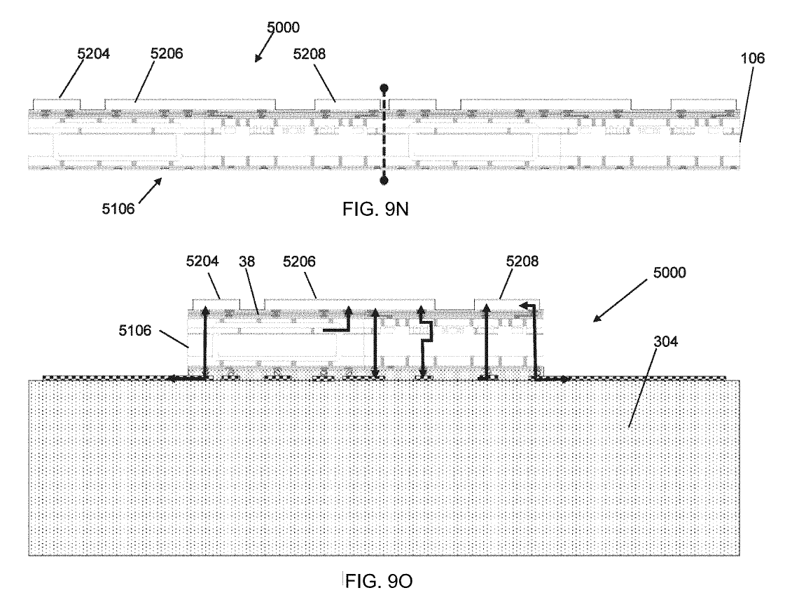

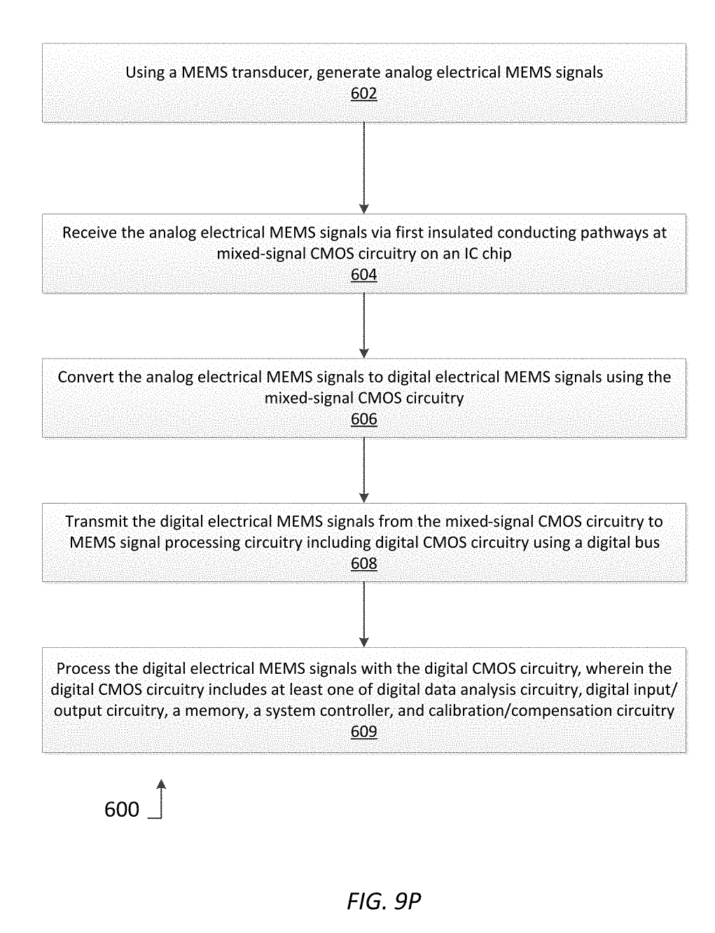

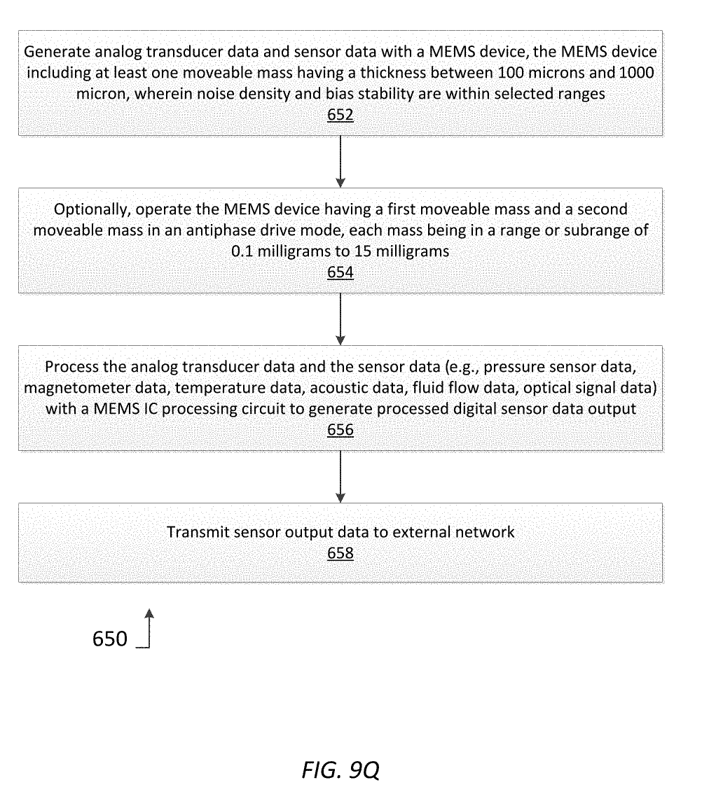

FIG. 9A shows an exemplary embodiment of a MEMS IMU 950 that can be mounted onto the sensing element of a sensor array. The MEMS sensor 920 includes a motion sensor 922, consisting of one or more proof masses 924 used to the detect acceleration and angular rate along three mutually orthogonal axes. The MEMS sensor 920 can include additional sensors such as a three axis magnetometer 926 or pressure sensor 928. Referring also to FIG. 9B, the 3D MEMS sensor 920 is integrated at the wafer level with a system IC 930 to produce a 3DS (3D System) component 950. The IC contains at least the functions required to operate the IMU. These include digital control circuitry, drive and sense circuitry for the various sensors (accelerometer, gyroscopes, magnetometers, pressure sensors), and analog to digital conversion circuits to produce IMU's digital output. Other functions which can be included in the 3DS MEMS IMU include wireless/GPS, calibration and compensation, microprocessor control, power management, data analysis functions, and advanced sensor fusion algorithms, transforming the 3DS MEMS IMU into a 3DS MEMS INU. The critical timing function can be provided by a separate low drift system clock to each IMU through its digital I/O port 940. A MEMS clock and timing circuit can be included in the MEMS chip. Alternatively, a low drift MEMS clock 960 can be fabricated as an additional device on the MEMS chip 920 (FIG. 9C) or included as a MEMS or quartz clock 970 on the IC 920 (FIG. 9D).

FIG. 9E illustrates another embodiment of an integrated MEMS system 2000. The exemplary 3DS MEMS chip 2100 is a hermetically sealed 9 degree-of-freedom (DOF) MEMS sensor chip, which includes an inertial sensor having at least 3 DOF and preferably a 6-10 DOF inertial sensor 2172 to measure x, y, and z acceleration and angular velocity and a 3 axis magnetometer 2176, all monolithically fabricated in the MEMS chip 2100.

The 6 DOF inertial sensor 2172 senses three axes of linear acceleration and three axes of angular rate. The 6 DOF inertial sensor 2172 includes first and second sets of electrodes 2180, 2182, respectively provided in the first and second cap layers 2120, 2140. One or several proof masses 2163, 2165 can be patterned in the central MEMS layer 2160, the first and second sets of electrodes 2180, 2182 forming capacitors with the proof mass(es). In FIG. 9E, only two proof masses 2163, 2165 are visible, but the 6 DOF inertial sensor 2172 can include more proof masses. The ultimate resolution of MEMS inertial sensors is set over short averaging times (<1 sec) by the noise density and over longer averaging times by the bias stability, which is roughly proportional to the noise density. The IMU noise density consists of two parts: an electrical noise density arising largely from the integrated circuit and a mechanical noise density arising from the MEMS sensor. A large MEMS sensor sensitivity, which is proportional for a gyroscope to the Coriolis force 2MωΩ (where M is the mass, ω is the drive frequency, and Ω is the angular rate), or for an accelerometer to the linear force Ma (where M again is the mass and a is the acceleration), minimizes IC noise. The thermal noise of the MEMS sensor itself is inversely proportional to the mass. So a large mass is key to reducing overall noise. The 6 DOF inertial sensor 2172 has large proof masses 2163, 2165 and sense capacitors 2180 hermetically vacuum sealed at the wafer level. It is important to keep MEMS sensor area small for most applications, so the disclosed sensor system maximizes the inertial mass by increasing its thickness. Using the disclosed architecture, the inertial mass is typically 400 μm thick but can range from 100 μm thick to 1000 μm thick, as compared to other MEMS inertial sensors which are 40 μm thick or less. The large proof mass is typically fabricated in a Silicon-on-Insulator (SOI) wafer having a handle which can be 100-1000 μm thick, a buried oxide layer 1-5 μm thick, and a single crystal silicon (SCS) device layer that is 1-20 μm thick. The bulk of the proof mass is etched in the handle wafer using Deep Reactive Ion Etching (DRIE) of silicon.

The mass of the proof thus can be designed anywhere in the range of 0.1 to 15 milligrams by adjusting the lateral dimensions (0.5 mm to 4 mm, for example, or having an area in a range of 1-3 mm2), thickness as described herein, or both. The springs which support the proof mass and the top of the mass are etched in the SCS device layer. The resonant frequency (√(k/M) can be tuned separately by adjusting the spring constant k through the thickness of the device layer and the width and length of the spring. The spring constant k is proportional to wt3/L3, where w, t, and L are the width, thickness, and length respectively of the spring. Lower frequencies (long, thin springs) around 1000 Hz are desirable for the accelerometer, while higher frequencies (short, wide springs) are desirable for the gyroscopes. Generally, resonant frequencies between 500 Hz and 1500 Hz are used for a variety of applications. The capacitor electrodes and gaps are etched into the faces of the cap wafers which are bonded to the MEMS wafer. The gaps are typically 1-5 μm thick providing sense capacitors which can range from 0.1 to 5 picofarads. Further details concerning fabrication and operation of MEMS transducer devices can be found in U.S. patent application Ser. No. 14/622,619, filed on Feb. 13, 2015 (now U.S. Pat. No. 9,309,106) and U.S. patent application Ser. No. 14/622,548, filed on Feb. 13, 2015, the above referenced patent and applications being incorporated herein by reference in their entirety.

For industrial, tactical and navigation grade applications, which include high resolution motion capture precise head tracking for virtual reality and augmented reality and personal navigation, the thick mass and as-fabricated high quality factor (˜5000) produce a gyroscope noise density ranging from 0.005 deg/√hr to 0.1 deg/√hr. The resulting gyroscope bias stability ranges between 0.05 deg/hr, and 1 deg/hr. This noise is lower than many fiber optic and ring laser gyroscopes that cost thousands of dollars more. Because existing consumer-grade MEMS gyroscopes use inexpensive packaging and have small inertial masses and sense capacitors, they have low quality factors and low angular rate sensitivities leading to large noise densities on the order of 1 deg/√hr and bias stability on the order of 10 deg/hr, inadequate for tactical and navigational use. Similarly, the accelerometer has a noise density ranging from 3 micro-g/√Hz to 30 micro-g/√Hz and bias stability ranging from 0.5 micro-g to 10 micro-g, much lower than consumer-grade accelerometers. The platform also allows the addition of other sensor types such as pressure sensors and magnetometers (shown here a 3 axis magnetometer 2176) to improve overall accuracy through sensor data fusion. The sensor data can be processed by data processor circuits integrated with the MEMS chip and IC chips as described herein, or by external processors. For navigation grade applications, which include high performance unmanned vehicle and autonomous navigation including in GPS restricted and GPS denied environments, two masses can be combined in an antiphase drive mode to not only increase the effective mass by a factor of √2, but to increase the quality factor by reducing mechanical energy losses. This approach can produce a gyroscope noise density ranging from 0.002 deg/√hr to 0.01 deg/√hr and bias stability ranging between 0.01 deg/hr, and 0.1 deg/hr.

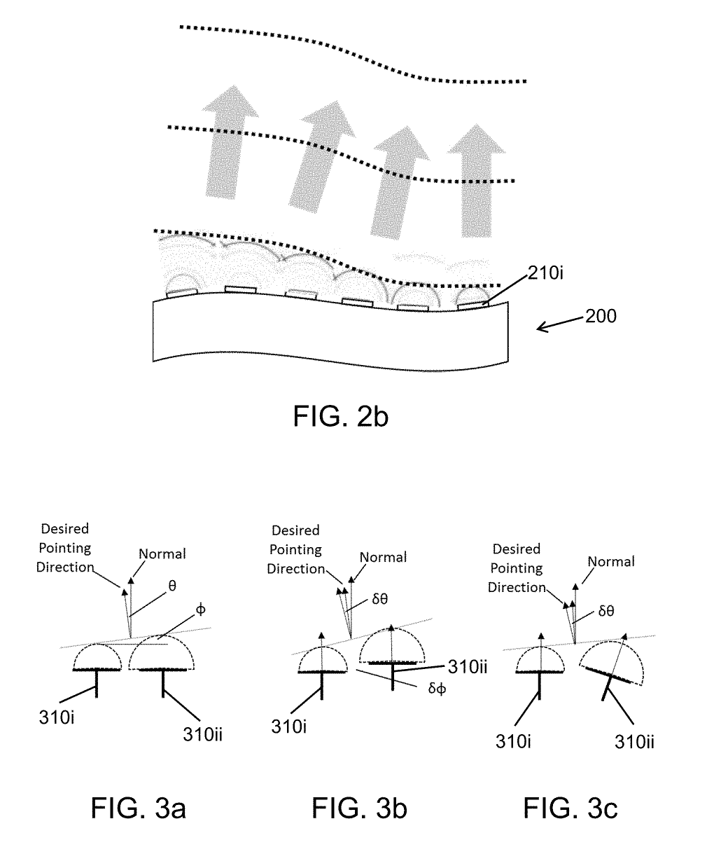

The MEMS chip 2100 includes first and second insulated conducting pathways, 2130, 2150, similar to those described previously. The first insulated conducting pathways 2130 connect the MEMS electrodes 2180, 2182 to a first set 2124 MEMS-electrical contacts, on the first cap layer 2120. The second insulated conducting pathways 2150 extend through the entire thickness of the MEMS chip 2100, allowing the transmission of auxiliary (or additional) signals through the MEMS chip 2100. The second insulated conducting pathways 2150 connect a second set 2126 of MEMS-electrical contacts of the first cap layer 2120 to some of the MEMS-electrical contacts 2144 of the second cap layer 2140. For clarity, only some of the first insulated conducting pathways are indicated in FIG. 9E, such as pathways 2130a, 2130d extending between the second cap electrodes 2182 and MEMS-electrical contacts 2124 of the first cap layer 2120, and pathways 2130b and 2130c, connecting first cap electrodes 2180 patterned in the first layer 2120 with MEMS-electrical contacts 2126 of the same layer 2120. Similarly, only some of the second insulated conducting pathways are indicated in FIG. 2A, such as pathways 2150a and 2150b, connecting electrical contacts 2124, 2126 in the first cap layer 2120 with electrical contacts 2144 in the second cap layer 2140.

Referring to FIGS. 9F and 9G, enlarged portions of possible variants of insulated conducting pathways are shown. In FIG. 9F, the insulated pathway is formed by a closed-loop trench 28 surrounding a conductive wafer plug 26. The trench has its respective sidewalls lined with an insulating material 30, and filled with a conductive material 32. Alternatively, as in FIG. 9G, the trench can be completely filled with insulating material 30. For both variants, the conductive wafer plugs 26 allow transmitting electrical signals though the cap layer, to the electrical contacts 42. Of course, since the insulated conducting pathways can extend through the entire thickness of the MEMS chip, the central and second layers can be patterned in a similar fashion, with the trenches of the first, central and second layers being aligned at their layer interfaces.

Referring back to FIG. 9E, the single MEMS chip can also include transducer(s) which are non-inertial sensor(s). Examples of possible non-inertial sensors include pressure sensors, magnetometers, thermometers, microphones, micro-fluidic and micro-optic devices. Other types of non-inertial sensors are also possible. The non-inertial sensor includes non-inertial electrodes patterned in at least one of the first and second layers. The non-inertial sensor also includes at least one MEMS structure patterned in the central MEMS layer, which can include non-inertial electrodes. Example of MEMS structures in a non-inertial sensor include membranes, such as those used in pressure sensor, microphone or magnetometer. Some of the first insulated conducting pathways in the MEMS chip connect the non-inertial electrodes to at least some of the first cap MEMS-electrical contacts, so as to transmit signals from the non-inertial electrodes to the bond pads of the first layer of the MEMS chip, which is in turn connected to the IC chip.

In the embodiment of FIG. 9E, the non-inertial sensor is a three-axis magnetometer 2176, which can be used to improve the accuracy of the inertial sensor 2172. The IC-electrical contacts 2228, 2230 (such as IC I/O bond pads) of the single IC chip 2200 are bonded directly to the MEMS-electrical contacts 2126, 2124 (such as MEMS I/O bond pads) of the single MEMS chip 2100, reducing electrical noise and eliminating wire bonding. The magnetometer 2176 includes non-inertial electrodes, such as electrode 2184, and resonant membranes 2167, 2169.

Analog data can be communicated between the MEMS sensors 2172, 2176 and the IC chip 2200 at an analog-to-digital converter (ADC) input/output mixed signal stage of the IC chip 2200. The MEMS signals generated by the sensors 2172, 2176 are analog signals, so they are converted to digital by the ADC to be further processed in the digital CMOS portion of the IC chip 2200. The data processing of the MEMS signals by the IC chip 2200 can include sensor calibration and compensation, navigational calculations, data averaging, or sensor data fusion, for example. System control can be provided by an integrated microcontroller which can control data multiplexing, timing, calculations, and other data processing. Auxiliary (or additional) signals are transmitted to the IC chip via additional digital I/O. The IC chip 2200 includes auxiliary signal processing circuitry, such as for example wireless communications or GPS (Global Positioning System) functionality. The GPS data can also be used to augment and combine with MEMS sensor data to increase the accuracy of the MEMS sensor chip 2100. These are examples only, and more or fewer functions may be present in any specific system implementation. As can be appreciated, in addition to providing the analog sensing data via the MEMS signals, the MEMS chip 2100 can also provide an electronic interface, which includes power, analog and digital I/O, between the MEMS system 2000 and the external world, for example, a printed circuit board in a larger system.

As per the embodiment shown in FIG. 9E, the single MEMS chip 2100 is integrated into the 3D MEMS System 2000 (3DS) and acts as both an active MEMS device and an interposer for signal distribution. One possible use of the 3DS architecture includes wafer-scale integration of the MEMS and IC, as schematically represented in FIGS. 9E to 9K.

FIG. 9H is a schematic representation of an IC wafer 220. An IC wafer can be constructed using any one of CMOS, Gallium Arsenide (GaAs) or other III-V compounds, Indium Phosphide (InP) or other II-VI compounds, Silicon Carbide, or other technologies. The IC wafer 220 includes several IC chips 2200. Each IC chip includes MEMS signal processing circuitry 2240 and auxiliary processing circuitry 2260, formed by IC transistors. The functionalities included in the IC chip can include GPS, RF, logic and/or memory. The IC wafer 220 also includes inter-level metal interconnects, and IC-electrical contacts, typically bond pads. The IC-electrical contacts are grouped in first and second sets of contacts 2228, 2230: the IC-contacts of the first set 2228 are designed to connect with MEMS-electrical contacts linked to the first insulated pathways, and the second set 2230 are designed to connect with MEMS-electrical contacts linked to the second insulated pathways.

FIG. 9I is a schematic representation of a multi-wafer stack 110, including several single MEMS chips, such as MEMS chip 2100 of FIG. 9E. The ASIC wafer 220 of FIG. 9H and the MEMS multi-wafer stack 110 of FIG. 9I can be fabricated in separate MEMS and IC foundries, in order to take advantage of existing processes to minimize cost and increase yield. In this example, two IC chips and two MEMS chips are shown, before dicing.

During the fabrication process of the MEMS stack 110, channels are etched in the first and second layers to define the borders of electrodes, leads, and feedthroughs on the inward-facing surfaces of the first and second silicon wafers. The channels are then lined, or filled, with an insulating material such as thermal oxide or CVD (Chemical Vapor Deposition) silicon dioxide. Both sides of the central MEMS wafer, which is typically an SOI wafer, are patterned with electrodes and MEMS structures, such as membranes and proof masses. Conductive shunts are formed in specific locations in the buried oxide layer, to allow electrical signals to pass from the device to the handle layer, through what will become the insulated conducting pathways. The central and cap MEMS wafers are also patterned with respective frames enclosing the MEMS structures. The various conducting pathways required by the device are constructed by aligning feedthrough structures on each level. The portion of the insulated conducting pathways in the central MEMS wafer can be isolated either by insulator-filled channels or by etched open trenches since the MEMS wafer is completely contained within the stack and the isolation trenches do not have to provide a seal against atmospheric leakage like the cap trenches. The frames are also bonded so as to form hermetically sealed chambers around the MEMS structures. After the wafer stack 110 is assembled, the cap wafers are ground and polished to expose the isolated conducting regions.

FIGS. 9H-9J illustrate a preferred way of bonding the MEMS and IC wafer 110, 220. An underfill 44 is applied to the top side CMOS wafer 220 and patterned to expose the IC electrical contacts (bond pads in this case). Solder bumps 45 are deposited on the bond pads. The IC wafer 220 is flipped and aligned to the MEMS wafer 110, such that the IC bond pads and solder bumps are aligned to the bond pads of the first cap wafer. The IC wafer 220 is bonded to the MEMS wafer 110 using temperature and pressure to produce a MEMS integrated system wafer.

The bonded 3DS wafer can now be diced (along the dotted lines in FIG. 9J) into individual integrated MEMS system components, also referred as 3D System on Chip (3DSoC). The exposed side of the IC chip is protected by an oxide passivation layer applied on the silicon substrate, and the MEMS/ASIC interface is protected by an underfill 44. The diced chips 2000 can be treated as packaged ICs and the bottom cap bond pads provided on the second cap can be bump bonded to the bond pads on a PCB 300, with no additional packaging, as shown in FIG. 9K. A PCB underfill 44 is applied to the PCB and patterned to clear contacts over the PCB bond pads. Solder bumps 45 are applied to the exposed PCB bondpads and the diced 3DS component chip 2000 can be flip chip bonded to the PCB 300. If additional moisture protection is desired, a polymeric encapsulant or other material 34 can be applied. No additional capping or bond wires are required.

Referring to FIG. 9L, to reduce the final device footprint area, an alternative architecture of the MEMS integrated system enables multiple single MEMS wafers 112, 104 to be stacked vertically, to form the 3DS MEMS wafer. FIG. 9L shows an IC-wafer 202 bonded to a multi-wafer 3DS MEMS consisting of two MEMS wafers 112, 104 of different device types, stacked and bonded to each other. By aligning the first and second insulated conducting pathways (also referred as 3DTCVs), MEMS and auxiliary signals can be routed through the entire stack of MEMS and ASIC chips, simplifying power bussing and minimizing lead routing between the various MEMS functions and the electronics. FIG. 9M shows the diced 3DS component 4000 consisting of a stack of an IC chip 4200 and two single MEMS chips 4102, 4104 bump bonded to a printed circuit board 302. In this case, the second layer of the single MEMS chip 4102 is bump bonded to the first layer of the additional single MEMS chip 4104. The second insulated conducting pathways 4150′ of the additional single MEMS chip 4104 is electrically connected to at least some of the second insulated conducting pathways 4150 of the first single MEMS chip 4102, to conduct auxiliary signals through the first and the additional single MEMS chip, to the auxiliary-signal processing circuitry of the IC chip 4200. The interconnected second insulated conducting pathways of the MEMS chips 4102 and 4104 allows to send auxiliary signals from the PCB up to the IC chip for processing, without requiring any wire-bonding.

MEMS signals for the MEMS chip 4104 can also transit through the MEMS chip 4102, up to the IC chip 4200. The first MEMS chip 4102 comprises a third set of first cap MEMS-electrical contacts and third insulated conducting pathways 4170 to connect the first cap MEMS-electrical contacts of the third set to at least some of the second cap MEMS-electrical contacts of the second cap layer of MEMS chip 4102, through the first cap layer, the central MEMS layer and the second cap layer. These third insulated conducting pathways 4170 are electrically connected to the MEMS signal processing circuitry 4240 of the IC chip 4200, and are electrically connected to insulated conducting pathways 4130′ of MEMS chip 4104. The MEMS signal processing circuitry 4240 can thus process the electrical MEMS signals of the first and of said at least one additional single MEMS chips. The MEMS-signal processing circuitry 4240 can thus process MEMS-signals from both MEMS chips 4102 and 4104.

Of course, while in the embodiment shown in FIGS. 9L and 9M there are two MEMS chips, it is possible to stack more than two MEMS chips of the same or of different types. An integrated MEMS system component can thus include a first single MEMS chip and additional single MEMS chips, stacked vertically.

Referring to FIGS. 9N and 9O, if the variation in IC types is too complex to be accommodated by a single ASIC (for example, mixed signal functions plus GPS functions, plus radio-frequency (RF) functions), the MEMS wafer stack 106 can be used as a 3DS substrate with a first IC chip to process MEMS and auxiliary signals, and additional IC chips 5204, 5206, 5208 of the desired types, such as GPS, RF, logic, processor, memory, and bump bonded to the one of the cap wafers of multi-wafer stack 106. Rather than using wafer bonding to attach a single ASIC wafer to the MEMS wafer stack, PCB chip attachment methods such as pick and place and solder bump attachment are used to align and bond the IC bond pads to the MEMS solder bumps, as in FIG. 9N. Each IC chip is thus individually placed and bonded to the MEMS wafer to form a 3D System Wafer (3DS wafer), the 3DS wafer being singulated into individual 3D System in Package (3DSiP) chips.

Referring to FIG. 9O, the MEMS metallization layer 38 in this case serves not only to connect the MEMS chip 5106 to the various ICs 5204, 5206, 5208, but also functions to interconnect the ICs and to provide signal and power distribution for them. In either case, after dicing, the individual 3DS components 5000 can be treated as a completed system chip, with no additional packaging or wire bonding. The system chip 5000 can be bump bonded to a PC board 304.

Referring to FIG. 9P, a process flow diagram is illustrated that describes a method 600 of operating a MEMS transducer device. Analog electrical MEMS signals are generated using a MEMS transducer (step 602). The analog electrical MEMS signals are received via first insulating conducting pathways at mixed-signal CMOS circuitry on an IC chip (step 604). The mixed-signal CMOS circuitry converts the analog electrical MEMS signals to digital electrical MEMS signals (step 606). The digital electrical MEMS signals are transmitted from the mixed-signal CMOS circuitry to MEMS signal processing circuitry including digital CMOS circuitry using a digital bus (step 608). The digital CMOS circuitry processes the digital electrical MEMS signals (step 609). The digital CMOS circuitry includes at least one of digital data analysis circuitry, digital input/output circuitry, a memory, a system controller, and calibration/compensation circuitry.

Referring to FIG. 9Q, a process flow diagram illustrated that describes a method 650 of operating a proof mass MEMS device in accordance with preferred embodiments of the invention. Transducer data and sensor data are generated with a MEMS device (step 652). The MEMS device includes at least one moveable mass having a thickness between 100 microns and 1000 microns. The mass area and thickness are chosen to provide noise density and bias stability values within selected ranges. Optionally, the MEMS device having a first moveable mass and a second moveable mass is operated in an antiphase drive mode (step 654). A plurality of masses is selected to reduce noise. The transducer data and the sensor data are processed with a MEMS IC processing circuit to generate digital sensor data output (step 656) as described herein. The device can then transmit to sensor output data by wired or wireless transmission to an external application by a communication network.

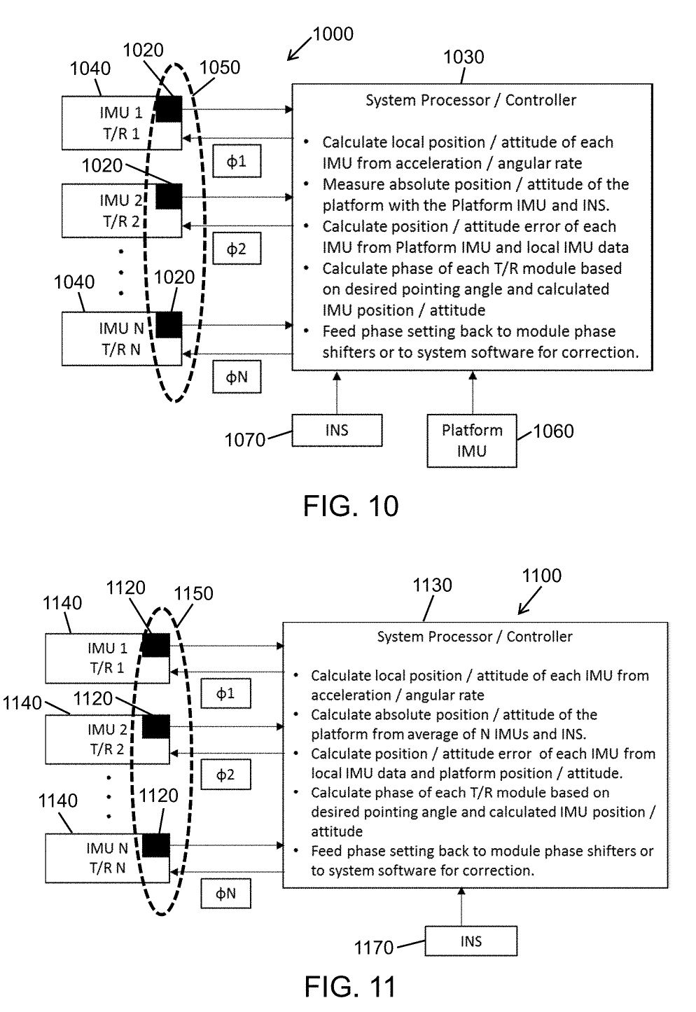

Referring to FIG. 10, one embodiment of a system process is outlined for a sensor array system 1000 with a platform IMU 1060 and an Inertial Navigation System (INS) 1070. Acceleration and angular rate data from each element's IMU 1020 is fed to a central system processor 1030 which calculates the position, velocity, and attitude of each IMU 1020. The position, velocity, and attitude of the platform are also measured by the platform IMU and inertial navigation system INS. The processor then calculates the absolute position and attitude of each sensor element based on the IMU data and individual MEMS IMU data. This positional and attitudinal data is then used to calculate the exact phase shift for each sensor element 1040 in order to transmit or receive a signal at a particular pointing angle.

FIG. 11 illustrates another embodiment of the system 1100 in which there is no platform IMU. Again, acceleration and angular rate data from each element's IMU 1120 is fed to a central processor 1130. Preferably, the higher frequency vibrational data is filtered either electrically or mathematically, through a digital or analog filter from the lower frequency data which includes the translational, rotational, and drift information. The position, velocity, and attitude of the platform can be calculated from the ensemble average of the low frequency IMU data and data from the inertial navigation system 1170. In this way the N IMUs form a “virtual system IMU” (VSIMU) 1150. As described earlier and illustrated in FIG. 10 the positional and attitudinal data for each MEMS IMU 1120 is then used to calculate the corrected phase shift for each element in order to transmit or receive a signal at a particular pointing angle.

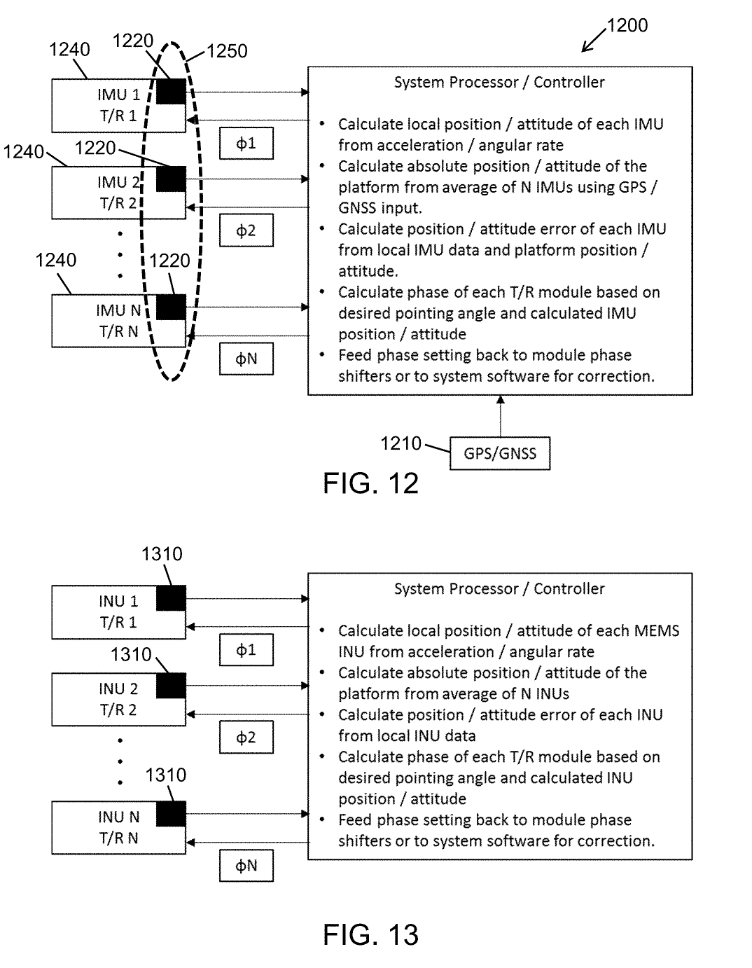

FIG. 12 illustrates a further embodiment of the system 1200 in which not only the platform IMU, but also the system INU are replaced. With the inclusion of Global Positioning Systems (GPS) and Global Navigation Satellite System (GNSS) modules 1210 the VSIMU 1250 can replace the system INU. While this might not be practical for safety reasons for manned vehicles, it can provide an attractive alternative to the very expensive system INU for unmanned vehicles where the vehicle and the sensor array platform are more tightly coupled.

By adding GPS/GNSS functions and sensor fusion algorithms, for example Kalman filters, to the IC, the 3DS IMU can be enhanced to become a 3DS INU. FIG. 13 illustrates a further system embodiment which includes an array of 3DS INUs 1310. Each 3DS INU calculates its own position and attitude and the system processor uses the data to determine the individual sensor elements' phase shifts as well as the position, attitude, and velocity of the sensor array platform and/or unmanned vehicle, thereby eliminating the need for either a platform IMU or a UV INU.

The sensor system can also be non-localized. That is, rather than being part of a fixed rigid or flexible array, the sensing elements can be distributed, for example in an array or group of semi-autonomous vehicles, such as unmanned air, underwater, and ground vehicles (UAVs, UUVs, UGVs), collectively referred to as UVs, each with at least one 3DS IMU, or on multiple space platforms or satellites. Position and attitude from each UV's IMUs is communicated to a central processor located either in one or more UV, or in a ground- or air-based control station via a communications system, that can be RF or optical, and of any topology, for example, point-to-point, star, ring, tree, hybrid, daisy chain, or other.

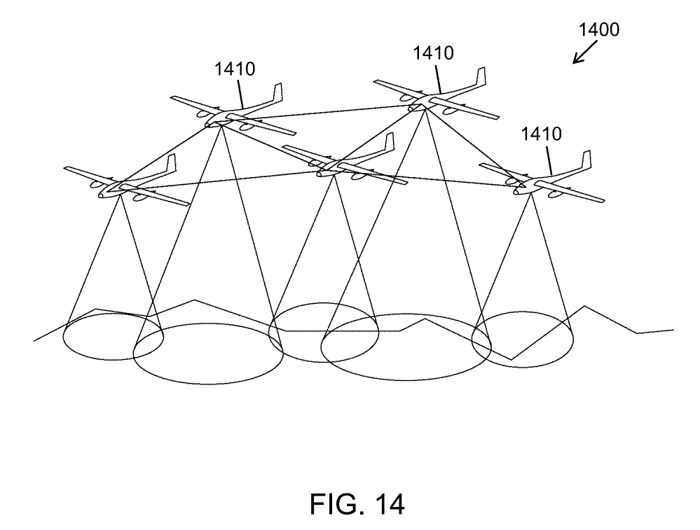

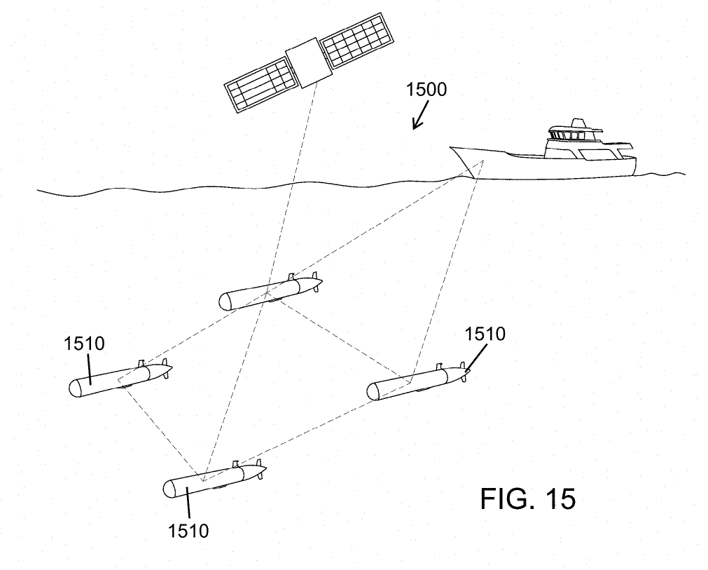

FIG. 14 shows a swarm of UAVs, each with a SAR, each UAV acting as a subarray 1410 of elements of a virtual array 1400. As described in the previous paragraph, the IMU data can be averaged to determine the position, velocity, and attitude of the ensemble of UAVs, thereby providing both the system INU function and the position/attitude of each UAV subarray relative to the system. The phase of each UAV subarray element can be compensated for to provide a mobile, large area sensor array. Similarly, as shown in FIG. 15, the unmanned vehicles can be a swarm of UUVs, or unmanned underwater vehicles, each with a SONAR, each UUV acting as a subarray 1510 of a virtual array 1500, and each with its own MEMS INU.

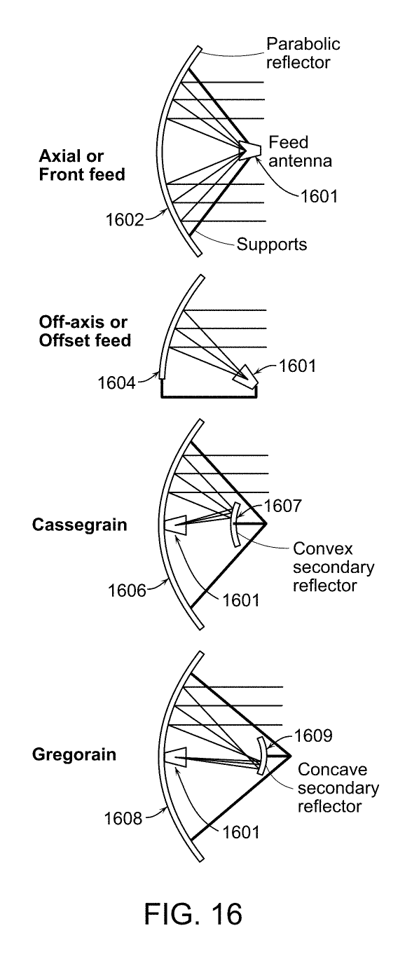

Antennas are critical elements of many electronic systems. An antenna is a specialized transducer that converts radio-frequency (RF) fields into alternating current (AC) or vice-versa. There are two basic types: the receiving antenna, which intercepts RF energy and delivers AC to electronic equipment, and the transmitting antenna, which is fed with AC from electronic equipment and generates an RF field. An antenna reflector is a device that reflects electromagnetic waves. Examples of antenna reflectors are illustrated in FIG. 16. In some embodiments, the antenna reflector can reflect the incident waves directly to a focal point for conversion o an electrical AC signal. For example, the axial or front feed antenna 1602 can reflect incident waves directly to an on-axis convertor 1601. Similarly, the off-axis or offset feed antenna 1604 can reflect the light to an off-axis convertor 1601. In other embodiments, the antenna reflector can reflect the incident waves to a subreflector that reflects to a feedhorn or other device for conversion to electrical signals. For example, a Cassegrain type reflector 1606 can use a convex secondary reflector 1607 to channel the light to the convertor 1601. In another example, a Gregorian type reflector 1608 can use a concave secondary reflector 1609 to channel the light to the convertor 1601. The relative motion between the solid or mesh surface and the feed antenna or array or the secondary reflector reduce antenna gain and directivity. Distortion of that surface through motion, vibration, wind, thermal loading, or any other force that increases the roughness decreases the gain and directivity of the antenna.

An antenna array is a set of individual antennas used for transmitting and/or receiving radio waves, connected together in such a way that their individual currents are in a specified amplitude and phase relationship.

A phased array antenna is composed of multiple radiating elements each with a phase shifter. Beams are formed by shifting the phase of the signal emitted from each radiating element to provide constructive/destructive interference so as to steer the beams in the desired direction. Phased array antennas can be arranged in linear arrays, which can form beams in one dimension and are typically moved mechanically, or planar arrays, which can generate 2D images. Phased arrays use computer controlled phase shifters to create beams. Nearly undetectable motion at a very low level affects the phase relationships between the elements.

For higher frequencies, the movement of those individual elements has a deleterious effect on operation of the phased array antenna. For the best performance, element motion of the reflective surface should be detected and compensated.

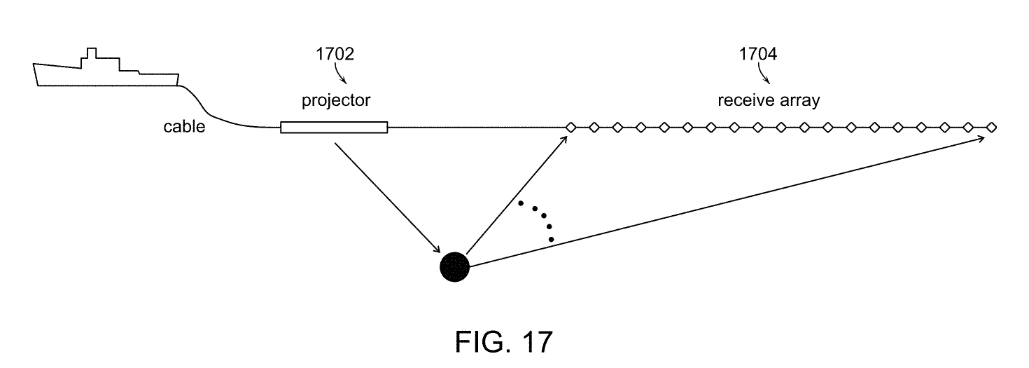

Sonars also typically use arrays, either planar or linear. Accurate motion data is crucial to the use of Time Difference of Arrival (TDOA) for Angle of Approach (AOA) analysis methods. This is particularly important in applications such as towed sonar arrays (FIG. 17), in which a towed array contains both transmit 1702 and receive 1704 elements arrayed along a cable. Such a structure is subject to motion through pitch, yaw, roll, depth and surging (i.e., acceleration along the direction of travel because of cable strum, ship motion, currents, etc.). These motions affect the phase relationships between the discrete elements. A 3DS MEMS 6 DOF or higher DOF device (true north sensor and pressure/depth sensor) placed on each individual element in the receive array can provide detailed motion information to allow motion compensation to optimize overall system performance through precise motion detection. As the acoustic element/receive arrays 1704 can be hundreds of meters long, the arrays can be equipped with Vibration Isolation Modules (VIMS) that act as a shock absorber, attenuating the effects of mechanical noise due to cable strum and ship motion. Strategically placed 3DS IMUs can provide detailed motion data to allow computation of motion correction and deployment of active measures to control hydrophone movement.

Phased arrays use computer controlled phase shifters to create beams. Nearly undetectable motion at very low levels affects the phase relationships between elements of the phased array. Detection of such relative motion can improve deployment of a variety of fixed, mobile and deployable antennas; solid or mesh reflectors; active or passive arrays; active, passive, acoustic, electromagnetic, and other phenomenon-sensing systems; terrestrial, underwater, and spaceborne apertures; monostatic radars; bistatic radars; multistatic radars; SIMO radar (Single Input/Multiple Output); MIMO radar (Multiple Input/Multiple Output); and sonars, including linear and planar arrays.

Antenna can be a generic term to describe a number of different apertures performing the functions of receiving or transmitting energy across a broad electromagnetic spectrum, from ultraviolet, visible and infrared light, radio frequency from ultra low frequency to the highest frequencies. Antenna reflectors are critical to amplify small signals and direct electromagnetic energy, either transmitting or receiving. Antenna reflectors can designed in many different styles and shapes, including but not limited to isotronic (regular shapes such as circles or squares); anisotronic (irregular shaped antenna); round; rectangular; oblong; or shaped as a three-dimensional object such as a sphere or hemisphere.

Antenna reflector surfaces can be smooth or rough in various embodiments. The antenna reflector surface can include a mesh of open structure with regular or irregularly dispersed elements to focus or reflect energy in a precisely planned manner. These surfaces can be fixed permanently or can be manipulated to alter and thus change their reflective/receptive characteristics. Antennas and antenna reflectors can comprise a plurality of regions wherein each region can have a MEMS IMU coupled thereto. The antenna region MEMS IMUs generate position and attitude data that can be processed by the system processor or controller to precisely control phase sensitivity of the antenna by altering the phase of sensed data or beam transmission signals as previously described herein. These antenna IMUs can be used alone or in combination with sensor array IMUs.

Antenna reflectors can be rigid or flexible, fixed or movable, rigid or semi-rigid. Any undetected and uncompensated movement can induce phase shifts in received and transmitted energy.

Antenna reflectors can be assembled once and never disassembled or can be designed to deploy or open from a stowed, inoperable position into an open, operational position. The deployment action can be performed via actuators powered by methods to include, but not limited to, hydraulic; pneumatic; pyrotechnic; gas generator; chemical processes; or electromechanical or mechanical (e.g., spring, torsion bar, elastic contraction, etc.) internal power. The deployment mechanism can include passive methods such as external aerodynamic methods (e.g., using forward motion of an aircraft to extract or open an antenna); hydrodynamic methods (e.g., using forward motion of a ship or submarine to extract or open an antenna), or mechanical properties such as spring tension or material memory.

A closed or stowed, furled, rolled, folded or coiled antenna or an antenna otherwise stowed in an non-operational state can be deployed by methods including but not limited to extending ribs like an umbrella, unfurling compressed flexible ribs, or extruding the coiled and compressed antenna via screws or other extension mechanisms.

As an example, one of the more complex and largest deployable antenna types is described in U.S. Pat. No. 5,990,851 entitled “Space Deployable Antenna Structure Tensioned by Hinged Spreader-Standoff Elements Distributed Around Inflatable Hoop”, the entire contents of which is incorporated herein by reference. The deployable antenna described therein is an example of using a complex mechanism to achieve several objectives including fitting a large area structure in a small volume, reliable and precise deployment, achieving a high degree of precision in ‘flatness’ (usually measured in roughness), high stiffness with light weight, and very light non-payload deployment mechanism elements (i.e., the non-operational aspects of the antenna once deployed). In some embodiments of the mesh style antenna described therein the elements can be built of materials that are highly thermally stable.

The use of precise, small, low power 6 DOF (or higher DOF) MEMS IMUs on these antennas is important because of their ability to measure precisely angular and linear acceleration. Such measurements are important in characterizing the performance of the antenna in research, development, manufacturing, deployment, operation, stability, movement, and deterioration.

Motion detection methods described herein are pertinent to fixed, mobile and deployable antennas, solid or mesh reflectors, active or passive arrays, active, passive, acoustic, electromagnetic, and other phenomenon-sensing systems, terrestrial, underwater, and spaceborne apertures, monostatic radars, bistatic radars, multistatic radars, MIMO radar, and SIMO radar.

One very important area for the application of 3DS MEMS to antenna surfaces arises when the aperture, i.e., the antenna area, goes from a rigid unibody reflective surface to a collection of reflective elements of a single antenna aperture integrated over time, often with techniques termed Synthetic Aperture, yet still a monostatic system, or a pseudo-monostatic system (i.e., one in which the actual transmit and receive apertures are separate but at a trivial distance such that they are close enough to be considered a single system for signal processing purposes).

The next embodiment relates to bistatic radars, in which the transmit and receive apertures are separated by a non-trivial distance. Again, the motion detection of the gross and finite elements of the receive aperture approximate a single system.

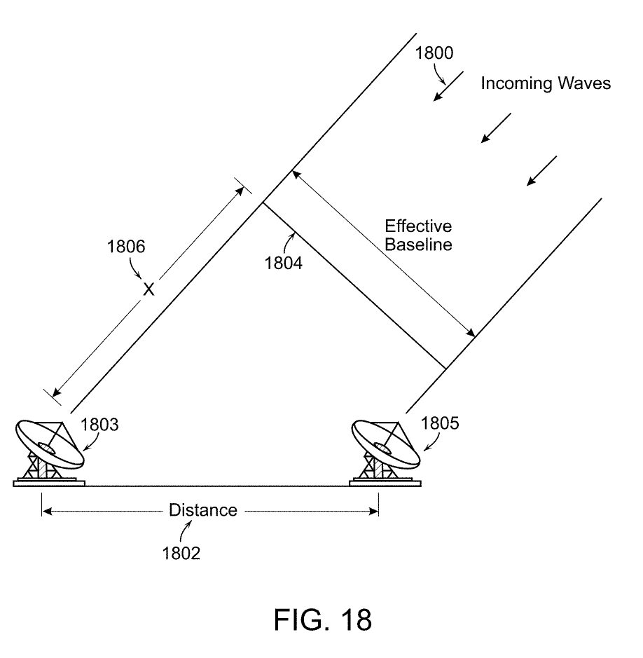

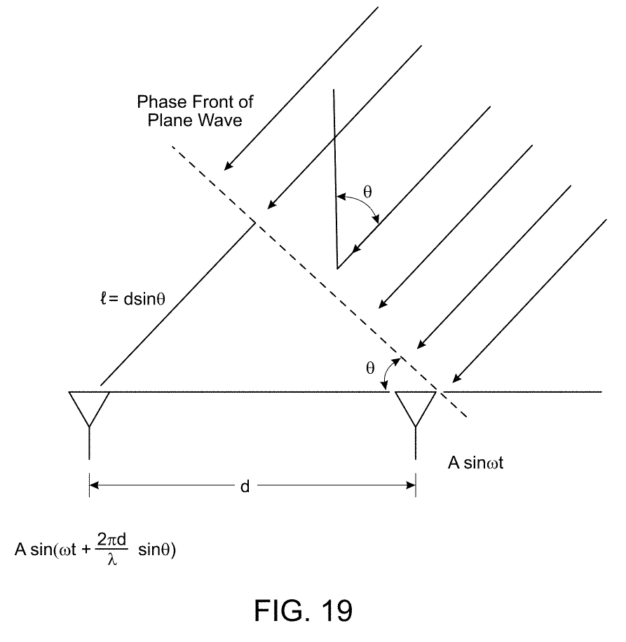

Time Difference of Arrival (TDOA) is a method of determining the Angle of Approach (AOA) of an incoming wave, which can be acoustic, radio frequency, or light. As shown in FIGS. 18 and 19, the wider the separation distance 1802 the larger the effective baseline 1804 with fixed, surveyed, unmoving receive apertures. The known distance X 1806 is the additional distance the wave 1800 must travel to reach the left hand aperture 1803 after the wave 1800 has reached the right hand aperture 1805. The speed can be a constant such as the speed of light or a medium-dependent speed such as the speed of acoustic waves through the atmosphere or water.

The MEMS die is inherently highly radiation proof and thus is well suited for spacecraft applications such as satellites. The ASIC can be replicated in radiation-hard material with radiation-hard design practices to make a space-qualified 3DS MEMS. Motion data from the 3DS MEMS can be processed at full data rate or at a sampling rate, allowing edge processing and reporting at low data rates. Both approaches will provide useful data.

Transmit and receive modules are critical to many types of advanced Synthetic Aperture Radar (SAR) and Inverse (ISAR) systems. SAR and ISAR systems are highly dependent on absolute movement, i.e., motion of the entire system, and relative motion (motion of the elements of the antenna in relation to each other), which can be measured by sensing rotational acceleration (measured by gyroscopes) and linear acceleration (measured by accelerometers) as described herein. A single 6 Degrees of Freedom (6DOF) MEMS IMU includes 3 gyroscopes and 3 accelerometers, for example.

An important aspect for large sensor arrays relates to “lever arm”—the distance between any element in motion and the center of the IMU. Placing the MEMS at the T/R module, for example, makes the moment arm negligible.

The 3DS MEMS is inherently resistant to high power radiation and temperature, which can be the environment of a T/R module. This design provides a high degree of accuracy in the small space dictated by the design of high power, high frequency T/R modules.

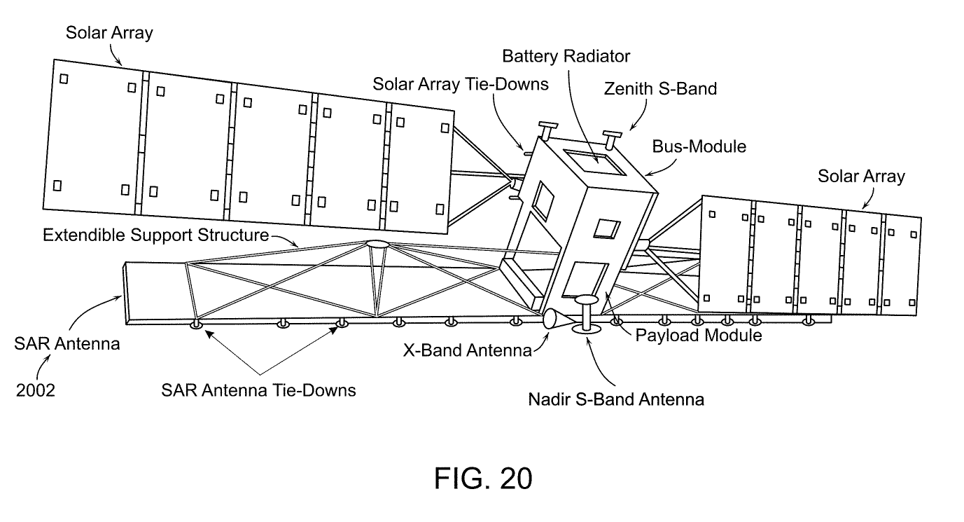

Placing 3DS MEMS IMUs in each T/R module provides gross and fine position and movement data. For example, the Canadian RadarSat (FIG. 20) has very long deployable radar panels that have embedded T/R modules. The multi-section, deployable SAR Antenna is subject to multiple sources of positional error, including but not limited to 1) transit, launch or deployment to include bending, warping, and 2) movement in operation because of thermal loading and distortion, spacecraft acceleration or repositioning, solar winds, or even impact with space debris. The outermost portion of such a long rectangular antenna, or even a round antenna, is most vulnerable to motion because of the lever-arm, the distance from the center, most solidly mounted and closest to the spacecraft body.

The impact of the distances between elements of the motion detection elements (e.g., GPS, IMU) and the theoretical center of the antenna and the actual discrete areas of the antenna is important. In this invention the lever-arm is such that any precise calculation of positioning and navigation data using exterior input such as satellite data from a Global Navigation Satellite System (GNSS) such as GPS along with IMUs, require that the lever-arm must be precisely measured.

Current practice is to use a single solution wherein a typical satellite, aircraft or ship uses both GPS and IMU information. The lever-arm between those units, and between them and the antenna aperture must be carefully calculated. In state of the art practice today, the center of the antenna aperture is used to approximate the motion for the entire aperture. The lever-arm is defined as the perpendicular distance from the fulcrum of a lever to the line of action of the effort or to the line of action of the weight.

All radar techniques require detailed knowledge of motion and compensation. Additional techniques beyond SAR and ISAR include Interferometric SAR (InSAR) in which two separate SAR images are taken from two different tracks. This and other types of advanced processing place a premium on precise motion data for compensation.

Another type of imaging radar for spacecraft or aircraft is bistatic (e.g., using one platform to transmit, or “forescatter” RF energy, and a second one to receive the backscattered, or reflected energy.) In the extreme example of the RadarSat in FIG. 20, the SAR Antennas are 15 m long and 1.5 m wide and weigh 700 kg. As the satellite body is about 1.5-2.4 m wide, the center of the antenna is up to 16 m from the farthest T/R elements. Such a lever-arm means that positional errors are greatly compounded. The MEMS array of sensors is distributed along the antenna at different distances from the center to address this problem. The plurality of IMUs generate data from different positions along the antenna that can be used to time the transmitted and received signals.

The figures illustrate only an exemplary embodiment of the invention and are, therefore, not to be considered limiting of its scope, for the invention may admit to other equally effective embodiments and equivalents thereof. The scope of the claims should not be limited by the preferred embodiments set forth in the examples, but should be given the broadest interpretation consistent with the description as a whole.

1. An autonomously navigated vehicle comprising:
an autonomous vehicle having an array of sensor modules, each sensor module including a light emitter and a light detector connected to a control system that performs time of flight (TOF) ranging;
each sensor module further comprising a microelectromechanical (MEMS) inertial sensor having a proof mass undergoing motion with at least 6 degrees of freedom (DOF); and
a processor that receives MEMS inertial sensor data to adjust vehicle operation.

2. The vehicle of claim 1 further comprising a mirror to control a direction of light transmission by a sensor module in the array.

3. The vehicle of claim 1 further comprising a steering circuit to adjust an orientation of a sensor module element.

4. The vehicle of claim 1 wherein each MEMS inertial sensor comprises a gyroscope, an accelerometer, a magnetometer, or a pressure sensor.

5. The vehicle of claim 1 wherein the MEMS inertial sensor comprises a proof mass having at least 10 DOF.

6. The vehicle of claim 1 wherein at least one sensor module further comprises a radar antenna having a MEMS inertial sensor.

7. The vehicle of claim 1 wherein the MEMS inertial sensor comprises a first silicon wafer bonded to a MEMS wafer.

8. The vehicle of claim 7 wherein the MEMS wafer is bonded to a second silicon wafer.

9. The vehicle of claim 7 wherein the MEMS wafer comprises a silicon-on-insulator wafer with a proof mass suspended in a cavity.

10. The vehicle of claim 7 wherein the MEMS wafer comprises a conductive pathway connected to the first silicon wafer through an insulating layer.

11. The system of claim 1 wherein the processor controls scanning parameters of each sensor module in the array, each sensor module including at least one of a LiDAR emitter and detector, a radar emitter and detector, and an imaging camera.

12. The system of claim 11 wherein the scanning parameters include beam signal amplitude, scanning beam direction and/or frequency.

13. The system of claim 1, further comprising a clock connected to each MEMS inertial sensor.

14. The system of claim 1, wherein each MEMS inertial sensor has a bias instability of less than 3 μg.

15. The system of claim 1, wherein each MEMS inertial sensor is stacked beneath the corresponding light emitter in each sensor module of the array of sensor modules.

16. The system of claim 1, wherein the MEMS inertial sensor is operatively associated with the light emitter, and wherein each sensor module in the array further comprises a second MEMS inertial sensor operatively associated with the light detector.

17. The system of claim 1, wherein at least one sensor module is mounted to a gimbal.

18. A method of operating an autonomous vehicle, comprising:
performing time of flight ranging using an array of sensor modules attached to an autonomous vehicle, each sensor module including a light emitter and a light detector connected to a control system and a microelectromechanical (MEMS)_inertial sensor having a proof mass that undergoes motion with at least 6 degrees of freedom (DOF);
receiving, at a processor, MEMS inertial sensor data from each MEMS inertial sensor; and
adjusting, using the processor, vehicle operation using the MEMS inertial sensor data and the time of flight ranging.

19. The method of claim 18, wherein performing time of flight ranging includes controlling a direction of light transmission for at least one sensor module using a mirror.

20. The method of claim 18, wherein performing time of flight ranging includes adjusting an orientation of an element of at least one sensor module element using a steering circuit.

21. The method of claim 18, wherein each MEMS inertial sensor comprises a gyroscope, an accelerometer, a magnetometer, or a pressure sensor.

22. The method of claim 18, wherein the proof mass in each MEMS inertial sensor undergoes motion in at least 10 DOF.

23. The method of claim 18 wherein at least one sensor module further comprises a radar antenna having a MEMS inertial sensor.

24. The method of claim 18 wherein the MEMS inertial sensor comprises a first silicon wafer bonded to a MEMS wafer.

25. The method of claim 24 wherein the MEMS wafer is bonded to a second silicon wafer.

26. The method of claim 24 wherein the MEMS wafer comprises a silicon-on-insulator wafer with a proof mass suspended in a cavity.

27. The method of claim 24 wherein the MEMS wafer comprises a conductive pathway connected to the first silicon wafer through an insulating layer.
